(19) United States
(12) Patent Application Publication
(10) Pub. No.: US 2005/0114653 A1
(43) Pub. Date: May 26, 2005

(54) Certificate revocation notification systems

(76) Inventor: Frank W. Sudia, San Francisco, CA (US)

Correspondence Address: Patent Group;Choate, Hall & Stewart, Exchange Place, 53 State Street, Boston, MA, 02109-2804, US

(21) Appl. No.: 10/949,713

(22) Filed: Sep. 24, 2004

Related U.S. Application Data
(63) Continuation of application No. 09/617,050, filed on Jul. 14, 2000.
(60) Provisional application No. 60/143,852, filed on Jul. 15, 1999.
(60) Provisional application No. 60/147,696, filed on Aug. 6, 1999.
(60) Provisional application No. 60/149,315, filed on Aug. 17, 1999.
(60) Provisional application No. 60/154,088, filed on Sep. 15, 1999.
(60) Provisional application No. 60/168,002, filed on Nov. 30, 1999.

(51) Int. Cl. H04L 9/00

(52) U.S. Cl. 713/158

(57) ABSTRACT

A revocation notification system for a public key certificate and associated method are provided. At the time of issuance, a CA requests and receives from an independent revocation service provider entity a THV corresponding to an IRV under the sole control of said revocation service provider. It then embeds such THV into the public key certificate and digitally signs the public key certificate with a private key. An entity requests revocation from the revocation service provider. The revocation service provider ceases publication of valid PFI updates for the public key certificate.

### 1.1. CROSS REFERENCE TO RELATED APPLICATIONS

The present application claims priority under 35 U.S.C. § 119(e) of U.S. Provisional Patent Applications Nos. 60/143,852, filed on Jul. 15, 1999, 60/147,696, filed on Aug. 6, 1999, 60/149,315, filed Aug. 17, 1999, 60/154,088, filed Sep. 15, 1999, and 60/168,002, filed Nov. 30, 1999, the disclosures of which are expressly incorporated by reference herein in their entireties.

### BACKGROUND OF THE INVENTION

1.2. Field of the Invention

This invention pertains to fast and secure systems for controlling access to data and network resources, and providing privacy and authentication of data, in electronic commerce on the Internet.

More particularly, in a public key infrastructure (PKI) where digital certificates are used to identify digital keys, which in turn are used to perform transactions, there is a need to communicate current revocation status information to a relying party, to allow that party to determine whether the certificate is still valid, or has been revoked by the issuer.

1.3. Background Information

Many systems for PKI certificate revocation have been designed and deployed, including Certificate Revocation List (CRL), Open Certificate Status Protocol (OCSP), Validation Authority (VA), and Reliance Management (RM). Additional systems have also been proposed, including the Micali Certificate Revocation System (CRS), which may require less network and computing resources to accomplish revocation notification.

### SUMMARY OF THE INVENTION

The present invention constitutes a system to efficiently revoke certificates, portions of which are based in part on the Micali certificate revocation system (CRS) protocol. See U.S. Pat. No. 5,666,416 and U.S. Pat. No. 5,960,083, which relate to the Micali CRS protocol. U.S. Pat. No. 5,666,416 and U.S. Pat. No. 5,960,083 are hereby expressly incorporated by reference in their entireties.

Other concepts represent applications of PKI technology that may at some point require a certificate revocation function. In these situations, a variation of CRS may be specified to perform the revocation notification step. However, such notifications to the relying party could also be performed using another revocation technology.

1.4. Related Art
Adams C. and R. Zuccherato, “Data Certification Server Protocols,” Internet draft, September, 1998.
Adams, C., presentation to NIST PKI CRADA, September, 1998.
Aiello, W., S. Lodha, R. Ostrovsky, “Fast Identity Revocation,” 1999.
Ankney, R., “Certificate Management Standards,” April, 1999.
Ankney, R., A. Asay, F. Sudia, P. Turner, U.S. Pat. No. 5,903,882, May 11, 1999, “Reliance Server for Electronic Transaction System.”
Ankney, R. and F. Sudia, ANSI X9.45 “Enhanced Management Controls Using Attribute Certificates.” American Bankers Association.
Branchaud, M., “Caching the Online Certificate Status Protocol,” Internet draft, April, 1998.
Ford, W. and P. Hallam-Baker, “Enhanced CRL Distribution Options,” Internet draft, August, 1998.
ITU-T Recommendation X.509, “The Directory: Authentication Framework,” 1997. Also published as ISO 9594-8.
Kocher, P., “A Quick Introduction to Certificate Revocation Trees.” 1997.
Kocher, P., U.S. Pat. No. 5,903,651, May 11, 1999, “Apparatus and method for demonstrating and confirming the status of a digital signature and other data.”
Malpani, A. and P. Hoffman, “Simple Certificate Validation Protocol,” Internet Draft, Jun. 25, 1999.
Merkle, R., U.S. Pat. No. 4,309,569, January, 1982, “Method of Providing Digital Signatures.”
Micali, S., “Efficient Certificate Revocation,” MIT, 1996.
Micali, S., PCT WO-97/16905, “Tree-based Certificate Revocation System,” filed November, 1996.
Micali, S., U.S. Pat. No. 5,666,416, Sep. 9, 1997, “Certificate Revocation System.”
Micali, S., U.S. Pat. No. 5,717,757, Feb. 10, 1998, “Certificate Issue Lists.”
Micali, S., U.S. Pat. No. 5,717,758, Feb. 10, 1998, “Witness-Based Certificate Revocation System.”
Micali, S., U.S. Pat. No. 5,960,083, Sep. 28, 1999, “Certificate Revocation System.”
Myers, M., R. Ankney, A. Malpani, S. Galperin and C. Adams, “Online Certificate Status Protocol,” RFC 2560, June, 1999.
SetCo, “SET Secure Electronic Transaction Specification, Book 3: Formal Protocol Definition,” May, 1997.
Sudia, F., U.S. Pat. No. 5,659,616, Aug. 19, 1997, “Method for Securely Using Digital Signatures in a Commercial Cryptographic System.”

1.5. Definitions and Abbreviations
Periodic Freshness Indicator (PFI) means a predetermined hash value released as shown in Micali U.S. Pat. No. 5,666,416 as proof of the continuing validity of a certificate.
Daily Freshness Indicator (DFI) means a periodic freshness indicator whose periodicity or frequency has been defined to be “daily.”

Recertification means the act by a certificate authority or its designee of issuing the next PFI value, thereby extending the certificate's life for one more period.

| | |
|---|---|
| CA | certification authority |
| Cert | certificate |
| CVP | cert validity period (= notAfter − notBefore) |
| DFI | daily freshness indicator (PFI_{D}) |
| H^{X} | the Xth hash value in the hash chain |
| INV | initial “no” value, used to create TNV |
| IRV | initial random value (same as H⁰) |
| KTV | key transition value |
| N₀ | terminal “revoked” value, in cert |
| N₁ | hashes to N₀, indicates cert has been revoked |
| N_{X} | hashes to N₀, to indicate revocation reason |
| PFI_{X} | periodic freshness indicator, of period X |
| RA | registration authority |
| TGS | ticket granting server |
| THV | terminal hash value (for example, H³⁶⁵) |
| TNV | terminal “no” value (per Micali patent) |
| TPR | third party responder |
| TRV | transition release value |
| Yᵢ | same as PFI_{X} |

Other exemplary embodiments and advantages of the present invention may be ascertained by reviewing the present disclosure and the accompanying drawings

### BRIEF DESCRIPTION OF THE DRAWINGS

The present invention is further described in the detailed description which follows, in reference to the noted plurality of drawings by way of non-limiting examples of certain embodiments of the present invention, and wherein:

FIG. 1 is a schematic process of iterated hashing;

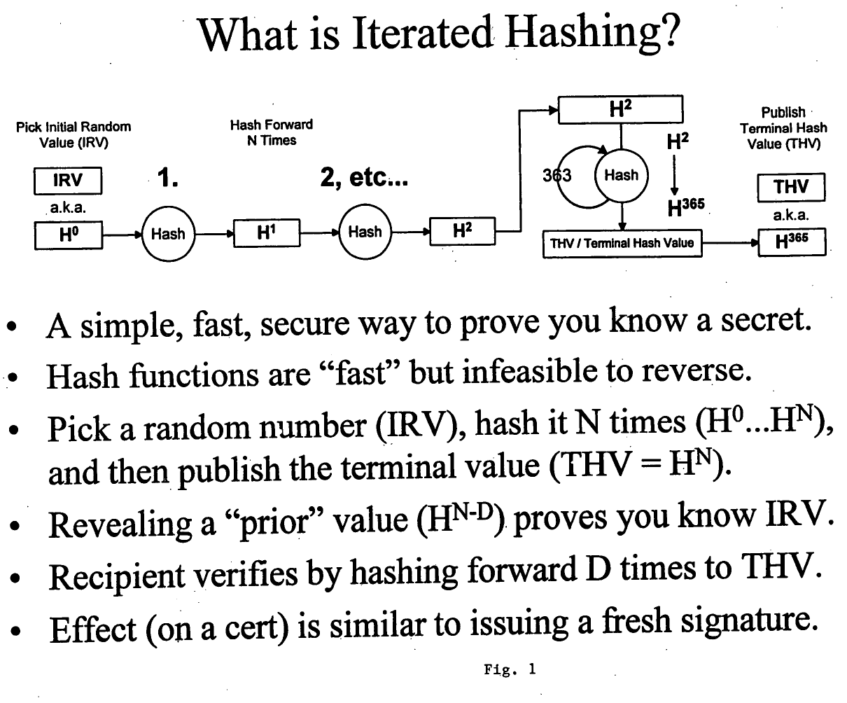

FIG. 2 is a schematic of an application of the present invention to secure E-mail;

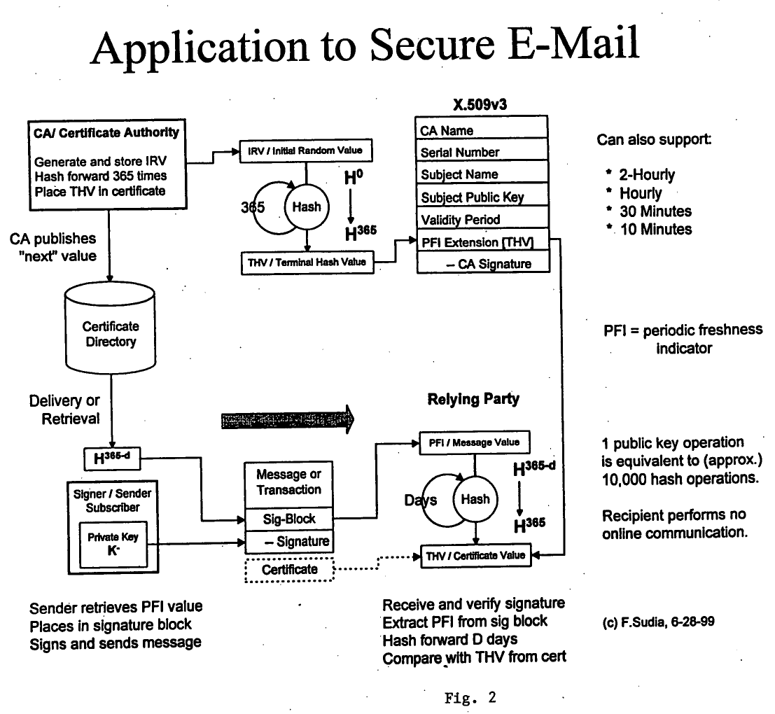

FIG. 3 is a schematic representation of an application of the present invention to Server Certs; and

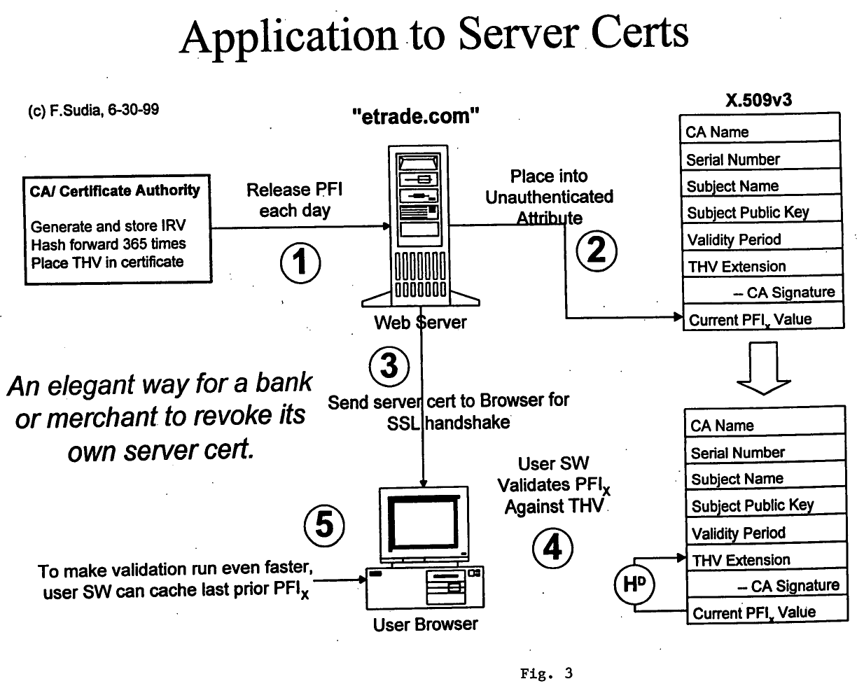

FIG. 4 is a schematic representation of the present invention within the structure of the market.

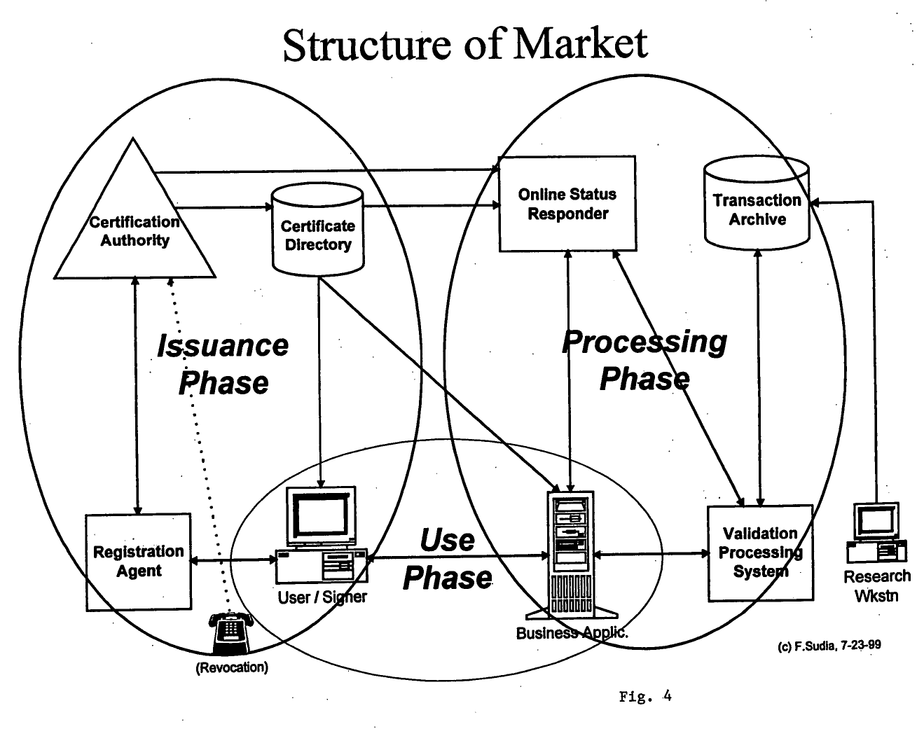

### DETAILED DESCRIPTION OF THE EMBODIMENTS OF THE INVENTION

2. Basic CRS Applications

When discussing certificate revocation, one tends to think initially in terms of a classical PKI model, in which Alice sends a message to Bob, etc. However, such a model has been very long in arriving, and may not be widespread for several more years. Meantime, one model that is in fact prevalent is web server certificates, which currently constitute most of the revenue of market leading CA service providers.

2.1. Web Server Certs

In this variation, the PFI system is not used for enabling or revoking user access to web sites. Most web sites are centralized or extranet services operated by a single party, such as a corporation, merchant, bank, or stock trading firm. These central providers do not need a third party revocation service to tell them which users are currently in good standing, because they themselves manage the process of enrolling and terminating their users. Also, very few users currently have their own certificates, because virtually all users access these central web servers using SSL.

However, a bank, merchant, or corporation could definitely use a way to revoke its own web server certificate, in case its system were stolen or compromised, to prevent the attackers from activating a fake service that tricks customers into believing it is the real one. Owing to the absence of deployed revocation solutions, it is difficult or impossible for an enterprise to revoke its web server certificate. This is currently an unmanaged computer security risk that is of concern to computer security experts and PKI architects.

By use of the PFI system, a major CA service such as VeriSign, could embed a THV extension into the web server certificate of a major merchant, such as Amazon.com, and then VeriSign could use the PFI system to issue a recert to Amazon on a daily basis, for Amazon to place into its web server certificate, in an unauthenticated attribute. (In ITU X.509 version 3, an unauthenticated attribute forms a part of the certificate data unit but lies outside of the signature computation, and thus can be modified without causing the signature to become invalid.)

Then, if Amazon's site were compromised and its private key stolen, Amazon could notify Verisign to revoke its certificate and stop issuing PFI updates. After the current PFI had expired, the users would all be on notice that certificate was no longer valid, without reference to any external directory or status checking service.

2.2. User Web Logins

Another application for the PFI system is to facilitate promiscuous end user web logins to disparate sources of content. This is more of a classical PKI application, but as with server certs, we are addressing a market that is closer to being ready to take off. Placing a PFI value into an unauthenticated attribute in a user cert that contains a THV attribute turns that user cert into a self-expiring ticket, similar to a Kerberos ticket, that grants time bounded access to some computer server resources. Many enterprises have already implemented the Kerberos methodology of short lived tickets for controlling access to distributed computing resources, and the uses and properties of tickets are well understood. Hence, it will be straightforward to substitute our PFI enabled X.509v3 certificate in those same applications, while adding the benefits of X.509 compatibility.

Such a ticket, most likely with a weekly expiration date, can be handled as an “encrypted cookie” by the user's web browser. This can allow the user to register to access numerous sources of web content, such as stock market or industry research, without needing to know or remember a different login ID and password for each service.

When confronted with the problem of registering for numerous different web servers, users will often use the same login and password for all such services. However, this is a bad security practice, since a compromise of one such login can compromise them all. Also, it may lead to a situation where a user uses the same login ID and password for a web content server as for a high security mission critical enterprise application, in which case the compromise of the web login can help an attacker compromise highly critical information on a different system.

It is therefore preferable to equip each user with a public key digital certificate, enabled with a (weekly) THV attribute, along with the matching private key, to use for client side authentication when conducting the SSL protocol with multiple web servers. When registering for access to a web content or transaction site, the user will be asked for the usual login ID and password, or alternatively to press a button to bring up a menu of his own user certificates, preferably THV enabled, to select one for use for future logins to that site. The certificate is sent to the web site, along with protocol material (such as a server-provided nonce) signed with the related private key, to demonstrate that the user possesses the private key.

Before signing with the private key, during enrollment or subsequent web logins, the browser may also prompt for a local wallet password, to insure that the right user is seated at the machine. Such prompting may be optional, in accord with the policy of the web server as articulated during the enrollment process.

At predetermined intervals, such as during power-on boot up, or once a day on schedule, or when about to use the cert, the browser will check the refresh status of the cert, and request a new PFI from the responder if the old one is stale. The system policy relating to PFI validity may provide a grace period on one or both ends of the stated PFI validity period, to allow greater ease in issuing PFIs before they become valid, or allowing continued use for a limited time after they have expired. (Some ticket based systems will allow a current connection to be maintained for a limited time after ticket expiration, but eventually force the user to log off until he or she obtains a more current ticket.)

The user cert, including its current PFI data (embedded in an unauthenticated attribute) will be treated as a ticket or cookie by the web content or transaction servers the user attempts to access. At time of issuance, the CA gives the user a sticker or (paper) wallet card containing a toll-free phone number to call if their machine is lost, stolen, destroyed or compromised. If that case, the CA/responder will cease issuing (weekly) PFI updates and the user cert will become useless.

Depending on how valuable the certificate is, the CA may wish to provide a suspend and reinstate functionality, as generally described in ANSI X9.55, in case an unauthorized party attempts to revoke it maliciously, or the report of compromise is in error. Malicious attacks may be feasible, since often the user has lost their keying material, and cannot strongly authenticate themselves. Hence, the CA cannot demand strong authentication of compromise reports. In that case, after a weakly authenticated or erroneous report of compromise, the CA will either investigate to determine if it was genuine, or the user will be given an opportunity to reauthenticate themselves, perhaps using a callback procedure, or a secret pass phrase (such as mother's maiden name). If the user is reauthenticated, the responder recommences issuing PFI values. This assumes the responder has not issued the N₁ “kill” value proposed by Micali.

This is similar to a method proposed by Valicert under which a sender can create and affix a digital signature to a message, attach a corresponding certificate, request and receive a freshness proof relating to the certificate from a server, and attach the freshness proof to the message. This allows the recipient to verify the current freshness without the need to request the freshness proof himself.

2.3. Caching of Prior PFI Values

The computation of the authenticity of the PFI in the Micali system is already much faster than any computation of digital signatures, while remaining equally secure. However, an additional speedup is achievable.

In any system or community in which entities (users or servers) often reauthenticate to the same trading partners, users/servers can cache the last validated PFI value received from a counterparty. This could be securely stored in an addional field in the user/server's record that contains that counterparty's certificate or other account information.

When an entity first receives a certificate from a new counterparty, it must perform the entire hash computation, hashing the PFI all the way back to the THV. However, this could (in a worst case scenario) be 11 months at 10 minute intervals, thus imposing a noticeable performance delay.

However, once it has performed that (long) calculation successfully, it can securely store the last PFI received, along with information about its period number. Then when a new session is initiated or message received, it can take the newest PFI and merely hash it forward until it matches the stored PFI value, using that to securely validate the current period number.

When parties communicate often, such as several times per week, using short revocation intervals, such caching can make the system more practical, by virtually eliminating the performance deterioration imposed by use of a short revocation period. This speedup should be applied whenever it is feasible. Even a casual SSL user who buys one book a month will achieve some speedup by caching the last PFI associated with the bookseller's server cert, possibly cutting compute time by 80% over the already speedy service offered by the PFI system, while granting the bookseller a convenient way to revoke its server cert if necessary.

Also, the PFI system in general, and especially this speedup enhancement, will be very useful in wireless communication systems.

2.4. Variations on Ticket Methodology

As noted in sections 2.1 and 2.2 above, placing a PFI value in an unauthenticated attribute in a public key certificate can cause the certificate to resemble a short lived access control ticket, such as a Kerberos ticket, for use in a distributed computing system. Such a hybrid certificate/ticket can be given other useful characteristics.

In addition to user authentication, as provided by an X.509v3 certificate, it is desirable to convey application-level permissions, including authorization to act in certain roles or perform certain functions, as defined in the application. This can be achieved by placing additional access control ticket information into the unauthenticated attribute, along with the PFI value, such as at least one data unit that contains role or function authorization codes, in which at least one field is encrypted (sealed) using a symmetric key known to both the ticket granting server (TGS) and the application server, but not to the client who is being granted access, in accord with well known principles of Kerberos. The TGS can form this data unit in response to a client request, and give it to back to the client, for use in obtaining access to servers or other resources in a computer network.

To securely link the ticket data unit to the client's public key certificate, the TGS can also place into the sealed ticket certain unique information from the user's certificate, such as a hash of the entire certificate (the authenticated portion), or a hash of some portion thereof, such as a hash of the CA name, user public key, and the certificate serial number. When this is encrypted using a symmetric key known only to the TGS and the application server, but not the client, it securely identifies that unique client certificate as the one to which the access permission is being granted. Such a ticket data unit normally contains an expiration time; however the TGS could further link the ticket to a given PFI value (and its associated validity period) by including the PFI value (or a checksum of it) in the sealed portion of the ticket.

Under the Kerberos model, the use of the shared symmetric encryption key to protect the ticket data unit also serves as the TGS's “signature” on that data. However, in the present embodiment, both the TGS and/or the user (certificate holder) can also digitally sign the ticket data unit, if desired. The ticket data unit can be delivered to the application server in any convenient manner, of which placing it in an unauthenticated attribute in the user's public key certificate is only one alternative. The ticket data unit can contain a plurality of such fields, each encrypted using a symmetric key shared between a TGS and a different application server.

The following is an example of the contents of a ticket data unit under this invention:

| | | | Hash of PK cert | |
|---|---|---|---|---|
| | User ID, password, | Time this | data (CA Name, | Checksum of |
| App Server Name | and group ID | access expires | Serial No, etc.) | PFI value |
| wire2.bank.com | jonesk, 0e$fzx, | 1999-07-15 | s3dk5jh7df9kjsvn2f | e9834ry4ru |
| | wire1pp | 4:00 PM | v4kn | |
| trust5.bank.com | kjones, fly2cast, | 1999-07-15 | s3dk5jh7df9kjsvn2f | e9834ry4ru |
| | clerk2 | 6:00 PM | v4kn | |

All fields in each row other than the App Server Name are encrypted using a key shared between the application server and the TGS but unknown to the user. The latter two fields are repeated because the two servers do not share keys and cannot read each other's data. The PFI value may expire at a different time than the access granted by the ticket, either before or after, due to differences in access control policies.

2.5. Use with Authority Certificates

The method of combining a public key certificate with a PFI value to form a ticket data unit can be extended to cover all types of digitally signed certificates, including attribute certificates, as such as those defined in ANSI X9.45. An attribute certificate may not contain a public key or even a user name, but will typically contain some predetermined coded fields to define the authority of the holder, digitally signed by a trusted authority. Such an attribute certificate may contain a link identifier field that uniquely links the attribute certificate to a related public key identity certificate, such that the two may be presented as a set (identity cert+attribute/authority cert) for purposes of both identifying an entity and representing facts about it, such as function or role based authority.

2.6. Revocation of Root Certificates

The problem revoking a root key has received little attention, perhaps because it is generally assumed to be impossible. In a hierarchical PKI, each end user must take physical delivery of the public key of the trusted root authority, which is then used to verify the certificates of (0 to N) mid-level CAs, which in turn are used to verify the certificates of individual users. Once physical delivery has occurred, there is no way to un-deliver it, short of posting an out-of-band notice in the news media notifying everyone to stop using it, as might be required in a disaster situation where the root private key was compromised.

The most common, and virtually universal, method for delivering a root key to an end user is in the form of a self-signed certificate, which either comes pre-installed in a software product (such as a browser or mail client) or is later imported and installed by the user. Once the root certificate is installed, the product typically allows an option to be selected to “trust” that certificate (as a root CA, etc.)

The preferred embodiment of this invention is to place a THV extension into the self-signed certificate of a root CA. This can allow the root CA, or another designated entity, to issue PFI updates to signify the continuing validity of the root certificate, and if PFI updates for a particular root certificate cease to be issued, then the end users (and their software packages) should cease trusting that root key for any further transactions.

If the root key is securely delivered to the end user in a different form (i.e., not as a self-signed certificate), the THV data can also be delivered along with it. However, this is less desirable because it is harder for the user application to verify that the data unit is intact. With a self-signed certificate, the user application merely needs to use the root public key to verify the signature, thus verifying that the root key data unit is intact.

This represents a very significant breakthrough in the management of root certificates, because it provides a simple and effective way for a root CA to promptly revoke its own root key in the event of a key compromise or other disaster.

To implement this system, we require that the user application will not trust the root key unless it can also verify a currently valid PFI for that root certificate. Current PFIs must be delivered to the client on a regular basis. However, this is not difficult, since a PFI is a small data unit, and other parties can routinely obtain the root-PFI and attach it to their transactions. Thus, the end user's software will probably receive the current root-PFI with its incoming transactions and certificates at least once a day, if not along with every transaction. It would be especially easy for major web servers to obtain a root-PFI from their root CA and transmit that to their end-users, along with the current PFI for their own server certificate. Or else the end user's system can hit the Freshness Server on booting up and request the current PFI for whatever root CAs it commonly relies upon.

As with other applications of the freshness PFI technology, the process of hashing the PFI down to compare with the THV embedded in the certificate can be greatly speeded up by caching (securely storing) the most recently received PFI, along with its period number, in which case when a more recent PFI is received, the user application merely needs to hash the new PFI value down until it matches the cached value, thus greatly reducing the number of hashing operations required to validate the PFIs of commonly used certificates, for which the user will often have a fairly recent PFI in its cache.

As described at length elsewhere in this document, we propose to associate a unique ID with each THV and PFI. Preferably the THV unique ID is based on an OID issued to the Freshness Service that issued the THV, and the PFI number is formed by adding the current period number to the OID for the THV. This can assist the user's software to determine which PFI goes with which THV, which will be a common problem if PFIs are received for a root-certificate, server certificate, etc. in the same message.

One possible reason why no one (to my knowledge) has bothered with revoking a root key is that it is generally assumed that such a revocation must be a digitally signed message, and hence would also need to be verified against a root CA, which might be the one that has been revoked, etc. Or alternatively, a false revocation message might be signed by a less trusted entity. These trust model problems have been puzzling. The present invention sidesteps them by providing continuing renewal of the assertions in the root certificate based on regular release of PFI values. Since this trust mechanism does not rely on digital signatures, it continues working when other systems may have become doubtful. All that is required is to guard against premature release of the PFI values with a degree of vigilance comparable to that used to guard the root CA's private key.

2.7. Root Key Transitions

When a CA desires to discontinue using one root key and begin using another, it is necessary to communicate this message to all holders of the prior root key, with great certainty and security. Yet this is difficult, because normally we do not know the “next” root key value at the time of distributing the prior one, and it is a doubtful practice to use the old root key to sign the new one, because we may be revoking it due to compromise or concerns regarding its security. For example, a recent advance in code breaking may have made the security of the prior key questionable. Thus there is doubt regarding the proper trust model for a root key transition. The present invention allows for increased safety and certainty in root key transitions.

2.8. Transition Release Value

In addition to placing a conventional freshness THV into the self-signed root certificate, as proposed above, we can include another hash value that is only a few hashes deep. It could be only one hash deep, but it may be preferable to make it 5 (or 100) hashes deep, in case some doubt emerges about the security of the hash function, which could make it possible to break a single round.

In this new invention, the additional hash value would be used to partially authenticate a root key transition instruction. As a distinguishing name, let us call it the Key Transition Value (KTV), and the securely stored prior value can be called the Transition Release Value (TRV). When creating a self-signed root certificate, the root CA places the KTV data unit into the root certificate, along with the THV data unit that will serve the revocation and freshness functions described above. Then the root CA will store the TRV under the highest conditions of security. By pre-agreement, when the root CA desires to transition to a new root certificate, it will retrieve the embed TRV into it, and promulgate it.

The TRV cannot by itself authenticate the new root certificate, because once it becomes public, an imposter can place it in a false replacement certificate. However, its absence can provide a useful safeguard, by signifying that the root CA does not presently desire to replace its root certificate, and the prior one remains unrevoked.

When the end-user software system receives the new replacement root certificate, it will note the presence of the Transition Release Value (TRV), hash it down the specified number of times, note that it matches the KTV embedded in the prior root certificate, and treat this as an assurance that it is okay to stop trusting the old root key and start trusting the new one. The new certificate will also contain a revised expiration date for the old root key. In cases of root key compromise this date may be in the past, which is useful to inform the system how far back prior transactions might be questioned.)

This is similar to the function Micali originally envisioned for N₀, to allow notice of revocation, except here N₁ also serves to authenticate the new replacement certificate.

2.9. Generalization: Robust Transitions

We could generalize this idea to employ other public-private key schemes. That is, in the present invention the KTV is like a public key that can verify an instruction that comes in the form of the TRV, which was previously a secret. The security of this notification method is based on the difficulty of breaking (N rounds of) the hash function. However, in the general case, when we are concerned about replacing a root key that may have become insecure due to advances in cryptology, we cannot know in advance which cryptographic algorithm may in the future become insecure.

Therefore, to provide a more robust notification method, we embed in the self-signed root certificate several additional public keys, preferably based on different public-private key cryptosystems, and require that the instruction to replace the root certificate needs to be authenticated using some quorum of the public keys.

For example, we might create and distribute a self-signed root certificate containing (1) a 1024-bit RSA root key, but also including (2) a DSA public key, (3) an elliptic curve public key, and (4) a KTV. Then we require that prior to transitioning to any new root certificate, the end-user system must validate the new self-signed certificate using at least three of the four prior public keys (RSA-1024, KTV, DSA, ECC).

3. Alternatives to Straight Hashing

While the use of a secure hash algorithm, such as MD5 or SHA-1, is the preferred method to produce the iterated hash chains utilized by the freshness system, there are other equivalent methods.

3.1. Iterated Symmetric. Cipher

A symmetric block cipher such as DES, Triple-DES, IDEA, RC5, Twofish, and many others can be used in an iterated feedback mode to produce a one-way chain of seemingly random values. In this mode, the initial random value (IRV) is chosen to include an initial random text and a random symmetric key, and optionally an initialization vector (IV) if desired. The randomly chosen symmetric key and IV are then used to encrypt the random text. These three values taken together (key, IV, and initial text) constitute the initial random value. The output of this initial encryption is the first ciphertext, and also serves as the next encryption key. This process can be repeated as many times as desired, with the output cipher text serving as both the input text and key of the next encryption, to produce a “feedback keyed hash chain” with the final value used as the THV. When successive prior key/texts are released, the users can encrypt them forward using the same symmetric algorithm to see if they yield the desired “THV.”

3.2. Alternating Hash Functions

Another variation is to alternate using a different hash function on different iterations of the hash chain. For example, a hash chain could be generated by alternating between SHA-1 and MD5 to yield the THV. Then as PFIs are released, the end users can also alternate the hash functions used to regenerate the chain and compare with the THV. In this case we need an indicator in the THV data unit telling them, for example that odd PFI periods use SHA-1 and even period numbers use MD5. Yet another variation is to base the choice of the next hash function on the least significant bit of the prior hash output. For example SHA-1 if the last bit is 1, and MD5 if it is 0. Such unusual hashing patterns can be commercially useful to create incompatibilities that distinguish between two different domains, which may have for example different trust levels. This in turn could provide a way to limit the use of certain certificates in environments where the policy is to forbid such certificates for reasons of commercial risk or liability.

This system can be extended to include any number or pattern of hash function types and symmetric cipher types, so long as the selection of the “next” hash or encryption function is readily determinable by the end user, either from a policy based on the period number, or from some bits in the prior output.

4. Issuance of PFI Values by Agents

The user certificate will typically contain a URL/URI indicating the source from which revocation, including PFI updates, may be requested. This information might be posted to a directory, or made available or issued by a responder (network server) under the control of the CA.

4.1. Third Party Responders

Such a responder could also be under the control of a third party. Such a third party responder [TPR] either requests or subscribes to certificate revocation information from the CA, such as a CRL update. Upon receiving the latest CRL update, it then issues the next PFI value Yᵢ, or fails to issue it, or issues the N₁ value, as appropriate.

The CA could at the time of issuance provide the TPR with the entire set of future PFIₓ responses, to be doled out over the valid lifetime of the certificate. This is like giving the TPR the IRV (=H⁰), and assumes a high level of trust between the CA and TPR. With less efficiency, the CA could give the TPR the next week's worth of PFI values, or such other pre-loading of the TPR that seems appropriate from a security risk standpoint. See more extended discussion below under Trust Model Issues.

4.2. Subscriber Controlled Responders

The TPR could also be under the control of the subscriber. For example a large merchant or bank may trust itself to handle the revocation of its certificate more than its CA. In this case, the CA could provide or contract with another for the provision of TPR service, and direct its CA to hand over the IRV (=H⁰) to a TPR of its choice. If the merchant or bank's web server were attacked, and its private key compromised, the merchant or bank could advise its TPR to cease publishing the PFIₓ (Yᵢ) values, and to issue N₁ when next requested.

5. Recipient Policy/Publication

A recipient can publish his preferred policy with regard to recency of recertification, to assist the sender in complying with it. When applying for a certificate, the subscriber can tell the CA what kind of revocation policy notification he desires from would be senders. This recipient policy can then be published in a directory, or placed in the recipient's certificate. A recency requirement can also be satisfied with other forms of revocation notification, such as attaching an OCSP or SCVP response to a message by the sender.

For example, at the time of issuance, the CA or a registration authority (RA) might solicit information from the applicant as follows:

Freshness service that you desire when you are the recipient:
Declared value of $0-$200=daily
Declared value of $200-1000=2 hours
Declared value of $1000-up=online
   or any contract=online

The statement “online” notifies the sender not to incur the cost or delay of requesting a more recent PFI_{X} indicator for a transaction over $1000, since the RP will go online to check revocation anyway. Alternatively, sender might include his most recent indicator anyway, to give RP the option not to bother if desired.

6. Using N_{X} to Convey Revocation Reason

The Micali CRS patent teaches the use of an N₀ value in the certificate. Release by the CA or responder of the value N₁, which hashes to N₀, signifies “no good” and constitutes a signature by the CA on a notice that the certificate has been revoked.

It appears feasible to enhance this mechanism to convey a reason for revocation. We can do this by coding and ranking Z possible reasons we might want to revoke the certificate, and then hashing forward Z times to generate N₀. We can then release a different value of N_{Z}, to signify the reason.

This mechanism does not provide “security” for the information, because there are several valid values, and an interloper can substitute one for the other. However, Micali's system allows us to dispense with the overhead of signature computations, so this should be explored as a way to convey desired information. Consider a policy under that has four revocation reasons:

| Code | Revocation Reason | Severity |
|---|---|---|
| 1 | Loss or Theft of Key | most serious for |
| | | recipient's risk |
| 2 | Change of Affiliation | still serious (person |
| | | may have been fired) |
| 3 | Change of Name | an issue for sender |
| 4 | Death or Cessation | serious for sender's |
| | of Business | reputation |

As a matter of “social engineering” let us assume that the revocation reasons the recipient is most concerned about are theft/compromise and sender possibly being fired; whereas the reason of greatest concern to the sender's reputation is death/cessation of business. That is, the recipient would prefer if the “danger” values cannot be downgraded in transit, and sender would prefer if the “out of business” value cannot be maliciously substituted.

Thus we can assign the “No” series as:

| | |
|---|---|
| N₅ | terminal “No” value (TNV) in cert |
| N₄ | Loss or Theft of Key |
| N₃ | Change of Affiliation |
| N₂ | Change of Name |
| N₁ | Death or Cessation of Business |
| N₀ | initial “No” value (INV) |

Note that we are reversing the numbering, in keeping with the “direction” of hashing for this attribute. “Terminal no value” (TNV) means the separate THV we are assigning for this special purpose, and “initial no value” (INV) means the special IRV that we used to create the no series.

Under this scheme, the “loss or theft” value cannot be converted to a value that implies less security risk for the recipient, or does more reputational harm to the sender. A malicious attacker can substitute a more serious warning for a less serious one, which is probably not in their interest, or substitute a meaningless value, in which case the non-existence of the next valid PFI_{X} implies revocation.

7. Recertification Schema Variations

The Extension and pfiExtension are further defined in Section 8 below.

7.1. Multiple Recertification Intervals

The thvExtension may contain several different THV values, such as one each for weekly, daily, 2-hourly, and 10-minutely. This allows the subscriber to request on a regular basis a standard value, such as weekly for casual web-logins, or daily for ordinary e-mails and low value purchasing. Then if the recipient demands a more recent recertification, such as 2-hourly for a higher value transaction, the sender (or the recipient) can request that fresher value from the PFI responder.

7.2. Use of Secondary THV to Indicate Suspend

As discussed in ANSI X9.55, it may at various times be desirable to suspend a certificate without permanently revoking it, so that it can be reinstated later. Reasons for doing this include (a) to buy time to investigate a report of compromise of a high value CA, to avoid liability in the event of a false or erroneous report, (b) when issuing a certificate, to allow time to make sure a smart card or token containing a private key has been delivered to the correct end user, or (c) when an employee goes on vacation (such as the “required” annual 2-week vacation for financial services workers, pursuant to US bank regulations).

The PFI protocol lends itself to de facto suspension by merely failing to publish the necessary PFI values for some period of time. However, an explicit suspend feature can be supported by embedding a separate THV to signal suspension. Then when the PFI responder is queried for the current PFI value, it can return a value for the current period that hashes to the “suspend” THV, rather than the “good” one, thus providing affirmative confirmation of the fact of suspension.

The periodicity of suspend PFI updates can be different (e.g., less frequent) than “good” PFI updates. For example, if a certificate receives “good” updates every two hours, the suspend periodicity might be 24 hours, to cut the processing required. By policy, we can provide that an unexpired suspend PFI will be superseded by a more recent “good” PFI, so the subscriber is not out of commission too long when the problem that led to the suspend has been resolved.

7.3. Rent-a-THV

The thvExtension may contain several different THV values for use by different parties for different purposes. For example, it could contain a daily THV for use with e-mail, and 5 weekly THVs for use with various subscription services that the user may wish to subscribe to.

When a user wishes to subscribe to a service, such as a source of technical information, the user and service provider will jointly apply to the responder for permission to use one of the weekly THVs as an indicator of subscription payment. Then, the responder will begin issuing recerts against that THV to the user, so long as the user remains a client in good standing. If however, the client decides to cancel the service, or is terminated by the provider (possibly for non-payment), or the client's private key is lost or compromised, then the responder will be notified and will cease issuing recerts against that THV.

If a given THV on a user's cert is not in use, or use by another service provider has been cancelled, then the user may apply to register that THV to another service provider, and in that case the responder will resume issuing recerts against that THV, which is now registered to the new service provider on the books of the responder.

The foregoing example relates to a promiscuous model in which the invention is used to provide an automated web login to unrelated service providers. This methodology could also be used to provide a way to authorize access to different applications within the extranet of a single enterprise. For example, an enterprise that used web servers for workflow and collaboration on a variety of projects could deploy an internal responder that registered a THV within a given user's cert to a given web application. Then the user's access to that application could be continuously recertified by the continuing issuance of PFI values against that THV, and so on.

7.4. User THVs with Different Responders

It is also possible for the user's CA to issue a certificate in which the multiple THV's in the certificate are controlled by different responders.

For example, a user's cert might contain 2 THV's, one controlled by the user's bank and the other by his corporate employer. Assume in this case that the CA was the user's bank. To create the certificate, the CA generates its own IRV and THV, and also receives from the user's employer another THV, where the employer's system retains control of the IRV and subsequent PFI values. Then, if the employer decides to terminate the employee, or merely suspend his cert while he is on vacation, the employer's responder can cease issuing PFI values, while the bank's responder continues as before.

Another example might arise if (a) several employers use a common CA and responder, such as for the aerospace industry, and (b) many of their employees need access to web sites of government agencies, which also share a common responder. When issuing an employee cert, the employers' CA could receive a suitable THV value from the government responder and embed that value in the certificate. Then the government responder could issue PFI values to indicate the person had continuing access to government systems.

In another variation, the government responder might issue a tuple of THVs (perhaps three), and then issue PFIs against one or more of them to indicate the employee's clearance level on different government controlled systems.

7.5. Recertification Start Offsets

This concept is further explained in section 8.3 below. A certificate might be issued with:
notBefore=1999-07-10-15:00:00.0000 (3 PM Sat Jul. 10, 1999)
notAfter=2000-07-10-15:00:00.0000 (3 PM Sat Jul. 10, 2000)

However, it may be preferable to begin issuing periodic recertifications at a different time of day, such as 6 AM. Hence, the thvExtension may contain a recertification startOffset value, which could be either an integer number of seconds, or an HH:MM time offset, to be added to the notBefore time to derive the starting point for recertification.

Such a startOffset could be negative, for example to set the recert starting point to a time prior to issuance. In case of a daily or weekly recert periodicity, this could allow the user to start using the certificate immediately, without having to wait until the next natural recert start time, which might not occur until the following Sunday.

7.6. Variable Periodicities using Templates

The time period for which a given recertification PFI_{X} value will remain valid need not be a fixed constant (e.g., daily, hourly) over the life of the certificate. The THV extension (or an external policy) can include a template that specifies the length of time each PFI_{X} value remains valid. Practical examples include daily or weekly templates. For example, a daily template can specify that there will be a series of issuances during the work day at the user's locale, and few or none during the night. A weekly template could specify different behavior for different days of the week, such as less frequent updates on weekends. Templates can “nest” within each other, such as different types of days within the week template.

For example:
weekday [d1]: {6 am, 8 am, 10 am, 12 pm, 2 pm, 4 pm, 6 pm, 12 am}
weekend [d2]: {8 am, 2 pm, 12 am}
workweek: {d2, d1, d1, d1, d1, d1, d2}

Each weekday has 8 recert periods, the weekend days have 3, giving a total of 46 periods for the workweek. In the base case, without such templates, we would be required to divide the week into 7×12=84 two-hour periods, even though such granularity may be unnecessary during non-business hours at the user's locale. Thus, in this example, the template approach gives a 45% reduction in hash computations.

Other template frames are possible. For example, an entire week could be divided into varying time intervals, without using two kinds of nested day templates. An annual template might be included, which sparsely indicates which day numbers are to be considered as holidays, which will follow the weekend pattern. Since there relatively few holidays, the incremental reduction of hash computations may not make a big difference. Such a table of exclusions might look like:
holidays-us-bank-1999: {1, 18, 46, 151, 186, 249, 284, 315, 329}
   Assuming a 52-week year using a nested template (weekday, weekend) scheme, the total number of hashes for the year will be 52×46=2392. If nine additional weekdays are treated as weekends, then the reduction of hashing is 9×(8−3)=45 (e.g., about 1 week's worth). This gives about 1.9% additional savings in the total (maximum) work factor, with the added communications cost of embedding the holiday table in the THV attribute and carrying it around in the user's certificate. This communication overhead might be reduced by carrying the holiday exclusions template in the root CA certificate, which in most cases the other party already has.

7.7. Disjoint Recertifications

Within a template based scheme, it might be useful to provide and communicate (via policies or extension codes) a policy that allows PFI recertifications to overlap in time.

In the workday scheme as described above, we might provide that while the CA will issue recerts at the times indicated, they will remain valid for 1 hour after issuance of the next recert. This approach can allow sender and recipient to get more use out of a given recert, before being required to request a fresher one, while at the same time giving the recipient the option to demand a fresher one if desired.

In the case of a daily or weekly recert, the policy could provide they remained valid for up to 4 hours or 1 day (respectively) beyond the next recert date and time. Other ways to implement this policy include: (a) allowing the CA to pre-issue the next period recert by in advance of the actual start date, or (b) allowing a grace period during which the last recert can still be used, such as to maintain an ongoing session, before the user must supply the next recert. Protocols can be defined to permit the parties to send recert information to each other during an ongoing session, to renew it without needing to logoff and restart.

Another potentially useful policy is to declare that the user's certificate is invalid for some period of the day or week, such as in the case of lower level employees, at night and on weekends. That is, there is a gap between the end of the last PFI notification period and the start of the next one.

8. PFI Protocol Semantics

It is desirable to specify an exact technical and legal meaning to the data values used in this protocol. Let us consider a base certificate containing the mandatory data prescribed by ITU X.509, plus the two certificate extensions proposed for this protocol.

8.1. Data Contained in Base Certificate

Version = 3
CA Name
Certificate Serial Number
Subject Name
Subject Public Key
Validity Period (notBefore, notAfter)
Authenticated Extensions:
thvExtension
CA Signature
Unauthenticated Extensions:
pfiExtension

The mandatory notBefore and notAfter values are assumed to contain complete date-time strings, of the form YYYY-MM-DD-hh:mm:ss.mmm, plus a GMT offset, such as −0500.

8.2. Rounding of Issue Date Values

If the protocol directly uses the beginDate and endDate values, it may be desirable that the values for all certificates be rounded to the nearest hour, to minimize the number of times the CA must send PFI_{X} (H^{X}) values to the responder. Alternatively, the CA may prefer to keep its issuance times continuously distributed, to minimize the number of PFI_{X} values needing to be processed at any point in time, and to provide temporal load balancing of CA updates to the responder.

8.3. Legal Semantics of Base PFI Protocol

In the base case, where there is only one periodicity, the PFI protocol message will have the following legally deterministic meaning:
At certNotBefore [GMT]
   +pfiStartOffset [HHH:MM:SS.MMM, or integer minutes]
   +(pfiPeriodNumber*pfiPeriodLength)
the CA said: “this cert is hereby recertified for pfiPeriodLength”,
   (but not to exceed the hard cutoff of certNotAfter), where
CA Signature={hash(pfiHashValue, pfiPeriodNumber)==thvHashValue}
   The function “hash( )” is defined here as: yhash=hash(xhash, N), where yhash is the product of iteratively hashing the input value xhash N times, in which the output hash value from each of the N hash operations is taken as the input to the next one.

8.3.1. Basic Extension Data

To achieve this effect, thvExtension, which is authenticated, must contain at least:
pfiProtocolId [OID, policyType]
pfiStartOffset
pfiTerminalHashValue
pfiPeriodLength [HHH:MM]
   And pfExtension, which is unauthenticated, should contain:
pfiProtocolId [OID, policyType]
pfiPeriodHashValue (required, self authenticating)
pfiPeriodNumber (optional, unauthenticated)
pfiNotAfter (optional, unauthenticated)

In the pfiExtension, the pfiPeriodNumber and pfiNotAfter values are optional because they can be computed by: use external time reference to determine the approximate expected period number, confirm the proper period (by hashing forward), determine the period start time, and add pfiPeriodLength to derive pfiNotAfter.

8.3.2. Verification Computation by Recipient

When the recipient's system receives the certificate and/or message conveying the pfiExtension, it must “hash forward” the pfiPeriodHashValue some number of times to see if it matches the pfiTerminalHashValue contained in the thvExtension. This raises the question of how many times it should hash and compare, if it does not find a match.

R1. Maximum N of periods to hash forward=CVP/periodLength

where CVP=(certNotAfter−certNotBefore)/periodLength. R1 states the obvious fact that we should stop after hashing forward the total number of periods of the certificate's entire validity period. This is clearly the outside boundary.

R2. Nominal N of periods to hash forward=((timeNow−notBefore)/periodLength)+allowedOverRun

A more normal stopping rule is stated in R2, which uses the external variable timeNow to computes the total number of periods that should have elapsed, plus some reasonable overrun.

If the PFI value is stale, then the calculation will find a match and halt prematurely, at a point in time in the past. Hence, an overrun (if it occurs) indicates that the PFI value was prematurely issued for a time in the future.

It may be desirable to design a message flow to allow recipients to report such an overrun to some authority, such as the CA, since it appears to indicate a malfunction, or possibly a compromise of the responder, wherein attackers have obtained future values and ineptly used ones that were not yet valid.

8.4. Extended Protocol Semantics

The legally operative semantics specified above can be extended in view of our proposed recertification schema variations.
1. Where there are multiple responders, or a given THV is registered to a given purpose or a given third party sponsor which is using it to grant access to its systems, then the semantics will be changed to substitute the different responder or sponsor as the entity making the statement, in lieu of the CA.
2. Where there is a variable periodicity, such as under the proposed template scheme, the date-time calculation and legal semantics will be changed to reflect the actual start and end times (pfiNotBefore and pfiNotAfter) that are reflected by a given PFI value, after stepping through the period counts provided in the templates.
3. Where there is a suspend (or disjoint) feature associated with a given THV, the semantics will be changed, in appropriate cases, to reflect that the entity is stating that the certificate is either suspended or temporarily invalid.

8.5. Display of Information to Users

In keeping with our attention to the business semantics of the PFI/THV protocol data, we must exercise care in displaying the information to the users, on screens and in reports, to insure they understand it correctly.

Consider a PFI process by which a CA located in California issues (at 4 am the CA's local time), a PFI intended for use by a sender in New York (commencing at 7 am the user's local time), where the sender (at 8:10 am) sends a transaction over the Internet to a recipient in Germany, who receives it at 2:12 pm Central European Time (CET)

8.5.1. Display to Sender

When printed or displayed by or for the sender, the CA's 2-hour recertification would read as:

| Recert 0375 | Sender's Time (NYC) | CA Time (California) |
|---|---|---|
| Issued at: | Jul. 12, 1999 | Jul. 12, 1999 |
| | 7:00 am − 0400 (EDT) | 4:00 am − 0700 (PDT) |
| Valid until: | Jul. 12, 1999 | Jul. 12, 1999 |
| | 9:00 am − 0400 (EDT) | 6:00 am − 0700 (PDT) |

This tells him clearly what he is about to send to the recipient. As a reference number, we might display the recert period number (0375 above). There are 4380 two-hour periods in a normal calendar year. The parallel display of CA time values is optional, but may be help the user/sender to understand the service he's getting from his CA responder, in case of problems or complaints.

8.5.2. Display to Recipient

When the recipient (in Germany) receives and prints or displays the recertification data, it might read as:

| | Recipient's Time | Sender Time |
|---|---|---|
| Recert 0375 | (Germany) | (New York, USA) |
| Issued at: | Jul. 12, 1999 | Jul. 12, 1999 |
| | 2:00 pm + 0200 (CET) | 7:00 am − 0400 (EDT) |
| Valid until: | Jul. 12, 1999 | Jul. 12, 1999 |
| | 4:00 pm + 0200 (CET) | 9:00 am − 0400 (EDT) |

This tells him clearly what he has received from the sender. Including the sender's recert reference number. The parallel display of sender time values is recommended, to allow the recipient to judge the time of day the transaction was sent in the sender's local time, to assess (especially in case of a human sender) whether that was a reasonable time for such a transaction to have been originated and released.

8.6. Refresh by Processing Intermediaries

In many corporate, government, banking, and workflow applications, it is common to require multiple signers (approvers) before releasing the transaction. The transaction may be held in a queue until all signers have approved it, in which case the PFI values on its certificates may become stale before it is released.

To alleviate this problem, the workflow processing or queuing server can, just prior to transmitting the transaction to a third party, request a fresh set of PFI values for all the certificates in the transaction. Alternatively, the recipient, at the time of accepting or relying on the transaction, can do the same.

9. Trust Model Issues

There is a growing awareness that revocation systems generally require the users to trust an additional entity, the revocation service or responder/server, in addition to the CA. In part this is because the online availability requirements of the responder/server are high, allowing for higher exposure to hacking attacks. Hence, it is undesirable for a CA server to also serve as a revocation responder, because the CA server should remain offline to better protect its private key from catastrophic compromise.

Also, there are different consequences regarding unavailability. If a CA becomes unavailable, such as due to computer malfunction or a failure of telecommunications or power, the only immediate result is that no new certificates can be issued until service is restored. Whereas if an online status checking service becomes unavailable, all users who rely upon it are precluded from transacting business (or do so at their own risk) until the service is restored. Hence, we are much more concerned about maintaining high availability for the PFI responder.

The PFI system raises the question of how much the CA should trust the responder with precomputed PFI values. It seems unadvisable for the CA to give the IRV values to the responder, because a compromise of the IRVs is very serious. It reveals all of the PFI values, and makes it impossible to revoke the certificates using the PFI system. It seems preferable for the CA to communicate the “next” value in advance of its issue date-time, and possibly a few more “next” values for efficiency reasons, to minimize communication between CA and responder, but avoid going further, to reduce the risk of compromising the entire PFI series.

9.1. Splitting the Hash Values

One way to address the risk of compromise or inadvertent premature revelation of the IRV or some future PFI for a given cert will be to “split” these values and store them in two or more different computer systems, in two or more secure processing facilities. A relatively easy way to accomplish such splitting is to XOR the set of all sensitive values with some set of random values, to produce a masked value set that when again XOR'ed with the same set of random values will yield the original sensitive value set. Initially the masked value set and random value set are stored on two different systems, and the sensitive value set is deleted. Then for relevant each time interval, the two systems cooperate with each other by revealing the matched pair (product+random) which are recombined to produce the sensitive value.

The CA or PFI responder can either combine the 2 values and reveal the result PFI_{X} to the user, or it could reveal the product+random values, leaving the user to combine them himself to form the current PFI_{X}. Another approach is to place 2 separate THV's in the certificate, and require two PFI's from different sources be supplied to prove validity.

Since all data values used in the foregoing, including the original PFI value set, appear to be well distributed random numbers, XOR should be an effective masking technique. We could also use encryption to mask them. Let the set of random values be employed as a sequence of encryption keys in which each successive random value is used to encrypt the next successive sensitive PFI value, using a symmetric block cipher, such as triple-DES. Then the key series and encrypted value series are stored on two different computers in separate locations, and the original value series is destroyed. At or slightly before the time of release of the “next” PFI value, the corresponding key and encrypted value are released, and the key value is used to decrypt the sensitive PFI value.

9.2. CA Populates Responder DBs Offline

In keeping with these considerations, a reasonable relationship between the CA and the PFI responder might be as follows. The responder service will maintain multiple network servers linked to multiple databases, to provide fault tolerance and load balancing. The PFI responder service can maintain two (or more) sets of databases, one containing the “current” PFI responses, and another containing the “next” PFI responses. It may maintain in different locations two copies of the “current” database, and two copies of the “next” database, and implement a private network connection with the CA, which is the custodian of the IRV values.

To perform the update process, the responder service can physically disconnect its (redundant) pair of “next” databases offline from the public network, and physically connect it to the CA via the private network, while they are being populated with the “next” PFI responses. After which it first physically disconnects the databases from the CA's private network. Then when the “next” values have become the “current” values, the responder service will physically reconnect those databases to the public network, and physically disconnect the former “current” databases, which can now be physically connected to the CA's private network, whereupon the CA can begin populating them with the “next” set of PFI values, etc.

This dual database refresh procedure can provide “air gap” security for the CA and its critical IRV values, while maintaining high availability and security for the PFI responder service. Such an approach is made easier by causing all PFI values to be reissued at the same times, so that they can all be placed on line at the same time. If their start times were widely distributed, then it would be difficult to use an offline method to populate the “next” database efficiently.

For increased security this air gap procedure can be combined with the split hash value procedure. The database of the online notification service, which has been temporarily taken offline, communicates via private network with two sources of notification data, such that the values received from the two sources (i.e., the random bit series and the masked data series) are recombined in the database, to form the true PFI values, and then at the start of the next revocation notification interval the database, thus refreshed, is placed back online where it is available to respond to inquiries.

9.3. CA Delegates Revocation to Responder

As a further concession to the requirements of this risk model, the CA could also delegate the entire responsibility for maintaining the PFI revocation system to the responder service. Under this approach, the CA would not generate the IRV value at all, but rather at the time of issuing a certificate, would apply to the responder service for an appropriate THV to be placed into the user's certificate, stating the policy requested, the number of periods, and so on.

Then the CA would bow out of the picture, and the responder would take over as the provider of revocation services on behalf of the user and the CA. The responder would safeguard the IRV value, compute and release the “next” values when required. In doing so it would probably follow an “air gap refresh” procedure similar to the one described above, between its secure storage location and the online databases, except it would be a logically separate entity from the CA, legally unrelated, providing the PFI revocation notification service under contract.

The CA's revocation notification service request to the PFI service will require a message format to define the parameters of the revocation notification service desired, as well as the subscriber's identity, contact, and billing information, to allow the PFI service to communicate with the CA's customer.

As with other types of revocation service, such as OCSP, LDAP, or reliance management (warranty protocol) larger independent CA's may wish to provide this service internally, whereas smaller less active CAs may wish to contract for it, and send their revocation notices to the PFI service provider, etc. This will be particularly relevant when the CA is an individual, such as a notary as provided under various US state and foreign statutes.

Refer to earlier discussions of third party and disjoint responders.

9.4. Backup OCSP Processing

We have noted that the PFI revocation protocol can be compromised if an attacker can improperly gain access to the IRV value. However, we have also provided (elsewhere) that PFI current period value can be delivered to senders or recipients using OCSP. In fact this may be the preferred mode of delivery, since it already exists and has industry acceptance.

This creates a situation wherein OCSP can be used as a secondary revocation method in case the PFI system were ever compromised. It is recommended that the PFI system NOT be used for high value transactions, in most cases, because a realtime online lookup is preferable, perhaps coupled with an identity warranty. Thus, if recipients adhere to such a policy, then they will perform an online lookup before relying on a transaction for a large monetary amount. At the time of performing the online lookup they may be told that the certificate was revoked, possibly at some time in the past, even if the sender has provided a current PFI value. Thus OCSP can serve as a backup revocation method, to enhance overall system security.

10. Billing Model Issues

The PFI revocation notification system affords several points at which users could be billed for the use of the service.
1. At the time the certificate is issued, the user can be charged (normally by the issuing CA) for incorporating the THV and related information into her certificate.
2. Entities that request PFI values, notably signers, recipients or refresh agents, can be billed (normally by the responder) for each request they make to the PFI responder.
3. It is also possible to link the client software to a digital rights management system, wherein money is debited from the user each time a PFI value is used, by either the sender or the recipient.
   11. Access Ticket Methods

11.1. Renewable Kerberos Tickets

The PFI methodology can be combined with traditional encrypted ticket or encrypted cookie access control methods that do not use public keys or digital signatures. In a traditional ticket, such as a Kerberos ticket, the ticket granting server (TGS), upon an authenticated request from a client, creates and returns to the client a data structure with at least two layers of encryption. A first layer, which is encrypted using a symmetric key shared between the TGS and the client, can be removed by the client to reveal a server name and network address in a form readable by the client (as in section 2.4 above). A second layer which is encrypted using a symmetric key shared between the TGS and the server, can be removed by the server to reveal a used login and privilege information in a form readable by the server.

The TGS also aids the parties (client and server) to establish a secure session between themselves by delivering to each of them (in both the inner and outer layers) a shared symmetric encryption key, such as a DES key, which the parties can use to communicate securely during their session, once it is established.

In a PFI enabled ticket, the THV can be embedded into the inner envelope (accessible only to the server), and the current period PFI value can be delivered to the client, for instance, in the first instance in the outer “client” section of the original ticket. Subsequently the “next” PFI value can be either (a) delivered to the client, which can in turn pass it along to the server with its next login request, or (b) delivered to the server, in response to a PFI check/update request from the server. PFI updates can be forwarded by the client or requested by the server to extend the life of an existing session between the client and the server.

The PFI system can enhance a ticket based methodology by providing a convenient and efficient way to extend the life of tickets, thereby reducing the need to reissue them. This can allow the tickets to have a much shorter base lifetime, such as two hours, instead of an entire work day, with refreshment via the release of a PFI every two hours.

11.2. Long Lived Association Management

This methodology can be further expanded into a generalized method for creating and managing long lived associations between clients and content servers. These associations are created and managed by a security administration application having a computer database containing (typically) a client table, content server table, a privileges table linked to said content server table, and an associations table, linked to all three of the foregoing and containing one record for each client-server association plus one or more codes indicating the privileges and authorities of that client on that server. This set of tables would be maintained by a security administrator, and be available to a ticket granting server.

The client table would also (a) contain information allowing the client to authenticate itself, such as a password or public key or state information for some token device they may possess, and (b) may contain or refer to the initial random value (IRV) or any precomputed PFIs that may be securely stored for future use. The server table would normally contain the symmetric (e.g., DES) key that was previously shared between the TGS and the content server for purposes of executing the Kerberos protocol.

Upon logging into and authenticating to the ticket granting server, the client would request and receive one or more Kerberos type tickets, each such ticket containing in addition the terminal hash value (and associated information), along with the server name and the inner encrypted portion, readable only by the content server, containing the client user's access permissions. The client could then retain these tickets, and employ them from time to time to gain access to content servers on the network, and the clients and servers could from time to time request the current PFI value for a given ticket, to determine if it was still valid.

These associations could be made extremely long lived, such as five years, with 2-hour (or shorter) periodicity, provided a PFI caching method is used to minimize computation when checking the current PFI value.

11.3. Encrypted Attribute Certificates

The shared symmetric keys of traditional Kerberos, that are used to produce the inner layer of encryption readable only by the server, can be replaced by a public key scheme, wherein the ticket granting server possesses instead the public key of the content server (normally obtained from a digital certificate signed by a CA), and uses that public key to form the inner encryption layer, normally using a key transport encryption method, such as the well known RSA-key-transport.

However, because anyone can form an envelope using the public key of the content server, the user access permissions contained in the inner envelope should be digitally signed by an authorizing authority, possibly in the format of an authorization attribute certificate, as disclosed in ANSI X9.45 and various patents by Sudia (e.g., U.S. Pat. No. 5,659,616) and Fischer (e.g., U.S. Pat. No. 4,868,877), wherein the terminal hash value (THV) is contained in an attribute or extension within the signed attribute certificate.

To more fully implement a public key scheme, the outer envelope (of the Kerberos ticket) that can be opened only by the client, can be formed using the public key of the client, obtained from the client's public key certificate, again normally using a key transport encryption method (like RSA-key-transport). This outer envelope can, as with normal Kerberos, contain the identity (name, address, and description) of the content server (to which the attribute certificate in the inner envelope will grant access) and other information that may be useful to establish or maintain a secure session with that server. This server identification data should also be signed, since as before anyone can form an outer envelope using the client's public key, and thus will most commonly contain the public key certificate of the server. The server's certificate may also contain a THV extension, and hence a fresh ticket could contain, along with a fresh PFI for the client's inner attribute certificate, a fresh PFI for the outer server certificate as well.

12. Recertifying a Signature

12.1. Background

In various business and legal settings, certain documents and filings are intended to be heavily relied on by third parties. Some examples include:
a certified financial statement signed by an auditing firm, that parties might rely on when extending credit,
a corporate filing with a government bureau (such as the SEC) that will be relied on by many investors,
a tariff filed by a telecommunications carrier that many other carriers or customers must read and be bound by,
representations made under a contractual relationship between two companies, which all their employees must abide by,
a pleading in a court case, where all parties are under oath and have an obligation to update their statements,
a certification of compliance with certain standards or regulations,
a master specification (such as for an aircraft design) that must be utilized by many subcontractors.

Or, in a PKI, as discussed elsewhere throughout these disclosures, a certification by a CA that it reasonably believes that a named entity has exclusive control of the private key corresponding to a stated public key.

In these and many similar cases, a party is required not merely to sign a document, but to continually recertify its reasonable belief in the truth of the factual representations made by the document. If for example an accounting firm begins to question whether a client's financial statement is really an accurate reflection of its position, it can “revoke the signature” on the financial statement, by calling the Freshness Server and instructing it to cease issuing PFIs.

12.2. Basic Process Model

To facilitate the rolling recertification by a signing party of an important document, the signing party, prior to signing, receives a THV from a Freshness Server having a suitable duration and periodicity, and contracts with the Freshness Server to release the related PFI values over time according to the release schedule implied by the chosen periodicity of the THV. At the same time, the signer registers a revocation a code word that upon communication back to the Freshness Server will cause it to cease issuing more PFI values, either temporarily or permanently.

Upon receiving the THV, the signing party incorporates it into his signature computation, for example by placing it in a signature attribute as provided in popular standards such as S/MIME and PKCS #7. Along with the THV, the signature attribute will also contain information on the periodicity, an unambiguous period-1 start time, and a reference to a network server (or class of servers) from which PFI updates can be requested. A party wishing to determine whether the signer still stands by the representations made in the document can contact the stated PFI server and attempt to obtain a current PFI value.

To facilitate management, all THVs should be unambiguously numbered, and all PFI values should be accompanied by their THV number and period number, to facilitate linking the THV and PFI data units together and performing the validation computations. In an electronic document handling system, the parties may be relying on important “master” documents on which they are basing a variety of important decisions, that may result in incurring large expenses, or taking significant business, technical, or safety risks. Whenever a party plans to rely or actually relies on the truth of a representation contained in a document issued by a different entity, it can check the signature on that document, determine the Freshness Server network address and THV number, and request a current PFI value. Upon receiving and validating the PFI value, the relying party can record and archive this information to provide later proof, if necessary, that it relied on a continuing, recently recertified representation contained in the said master document.

Other enhancements noted in this disclosure document, as well as our prior provisional patent application, can be applied to the THV process described herein, including use of (a) multiple THVs of differing periodicities (and different PFI costs) where different parties may require different levels of recency, and (b) the “template” concept whereby the periodicity of PFI issuance can vary by time of day and day of the week, to minimize the need for PFIs to be issued during non-business hours.

In a similar application, certain documents may contain legal representations about title to property or individual rights, notably when issued by a government or a bank, or in the case of an instruction to pay money of transfer property. Such representations or instructions may become false, or the signer may wish to countermand his instructions. Some pertinent examples include:

| Issuing Entity | Type of Document |
|---|---|
| Government | Licenses: driver's, marriage, contractors, |
| | medical doctor |
| | Security interests and liens filed under UCC |
| | Article 9 |
| | Liens secured by real estate |
| Account | Electronic checks |
| Holders | Multi-hop bank wire transfers |
| Insurers | Certificates of insurance, policy binder info |
| Banks | Letters of credit and documentary drafts |
| | Mortgages secured by real estate or |
| | equipment |
| | Underwritten commercial paper |
| | (corporate IOUs) |
| Notaries, | Notarizations of legal documents |
| Consulates | |

The placement of a THV information attribute in the signature computation of such important documents can allow two principal effects: (a) the signer can be held to the truth of its continuing representation, unless it issues an order to the Freshness server to revoke and stop issuing PFI values, and in the same manner (b) a signer can affirmatively countermand an instruction or representation that it has previously issued, by making it unreasonable for others to rely on it.

12.3. Second Embodiment

We prefer to implement this “signature revocation” capability by embedding a THV data unit in the signature, but it could be implemented more simply using digitally signed messages. The signer would obtain or produce a unique signature ID for each of its signatures, place that ID into the signature, and register the signature ID with an online signature status responder (after the model of an OCSP responder). The signature would also contain (1) a policy ID informing any relying party that the signature was subject to revocation, such that a signed proof of good standing from the signature status responder would be necessary prior to commercial reliance, and (2) a network address for one or more signature status responders.

This model is less advantageous since the proof of good standing request and response must be digitally signed, incurring the large computational time delay of creating and verifying digital signatures, along with the added communications burden in imposed by their greater length.

Also, while this model can allow greater flexibility regarding the type of assurance requested by the relying party, we do not believe such flexibility is necessary, because in most cases there is only one relying party who will be able to make a claim (against a single transaction), and the amount of reliance is known in advance, such that the RP has the option to reject the transaction if it does not feel that the reliance amount selected by the sender/signer is adequate to protect it. Such negotiation can occur outside the protocol. The result is that the assurance parameters of an individual signature can be set in advance, and be communicated in their entirety through the semantics of a single PFI.

12.4. Risk Management Model

In cases where a party is expected to rely on a digital signature, it is desirable to provide financial assurance that the party can be compensated if it suffers a financial loss due to its reliance through no fault of its own. This issue is addressed in U.S. Pat. No. 5,903,882, “Reliance Server for Electronic Transaction System,” issued Jul. 11, 1999.

Some of the risks that may arise when a party relies on a digital signature include:

| Risk Event Occurrences | Outcome or Effects | What the RP Needs |
|---|---|---|
| The digital certificate used | The signature is a | Identity warranty from the |
| to sign the document | forgery that does not | CA. |
| contains false | bind the purported | |
| representations and was | signer. | |
| procured by the signer | The CA may be liable | |
| through error or fraud. | for negligence. | |
| The subscriber's private | The digital signature is a | Insurance against forgery by |
| key was lost, stolen or | forgery that does not | unknown counterparties. |
| compromised, and its | bind the subscriber. | |
| digital certificate has not | The CA is probably not | |
| yet been revoked. | liable for negligence. | |
| The subscriber (or the | The digital signature is a | Insurance against forgery by |
| subscriber's employer) told | forgery that does not | unknown counterparties. |
| the CA to revoke it but the | bind the subscriber. | |
| revocation has not yet been | The CA is not liable for | |
| published. | negligence, so long as it | |
| | acts diligently in accord | |
| | with the terms of its | |
| | certification practices | |
| | statement. | |
| The subscriber (or the | The CA is liable for | A performance bond from |
| subscriber's employer) told | failure to act diligently | the CA, also known as errors |
| the CA to revoke it but the | in accord with the terms | and omissions (E&O) |
| CA delayed or failed to | of its certification | coverage. |
| publish the revocation. | practices statement. | |
| The digital signature and | Neither the CA nor the | A counterparty credit |
| certificate are valid, but the | PKI system are liable. | monitoring and evaluation |
| signer/subscriber cannot | This is a counterparty | system. |
| pay the obligation or | credit problem. The | A automated insurance or |
| perform under the terms of | relying party should | collateral posting system, |
| the contract created by the | have made a | wherein specified sums will |
| document. | determination of the | be paid to the RP in the event |
| | signer's | of credit default. |
| | creditworthiness prior to | |
| | relying on the | |
| | transaction. | |

The risks to the CA and relying party outlined in the table above can be addressed by creating a system that allocates capital or collateral to given parties and transactions where such capital or collateral is available to make a payment to a party who relies on a certificate or transaction and suffers a loss through no fault of its own, due to one of the covered risks.

12.5. Documentary THV Risk Account

Under the system of the present invention, when requesting a documentary THV for use in confirming the continuing validity of a digital signature, the signing party may specify a reliance limit and an expected time duration, which are associated to the THV in a risk account maintained by the Freshness Server.

12.5.1. Signature Database

The database record for the THV issued by the Freshness Server for use in the document may contain the following:

| | |
|---|---|
| Signature serial number | // allow multiple THVs per signature |
| Request date/time | |
| Signer unique ID | // preferably an OID (CA_OID, cert_no) |
| Document Type Code | // kind of document |
| Signer Role or Authority | // capacity in which signed |
| THV serial number | // globally unique (FS_OID, thv_no) |
| Terminal Hash Value | // uchar(20) |
| Pointer to IRV | // where Initial Random Value is located |
| Periodicity | // frequency of PFI update publication |
| Periodicity Template | // for uneven periodicity, if selected |
| Policy ID | // refers to incorporated terms and conditions |
| Assurance Type | // forgery, E&O, counterparty credit |
| Occurrence Limit | // monetary amount, per claim/occurrence |
| Aggregate Assurance | // max payable for this document |
| Assurance Template | // assurance can vary over time |
| Assurance Expires | // time after which coverage lapses |

The coverage limits could be different depending on the periodicity. That is, we might wish to provide (much) lower coverage limits for more infrequent periodicities. There can be different levels of assurance on the same THV related to different risks as noted in the above table. That is, the amount payable for forgery might be different from those payable for errors or omissions by the CA.

Upon request by a potential relying party, the PFI response from the Freshness Server will include the coverage limits associated with the periodicity of the THV for which the request is being made.

To increase speed, the relying party (RP) can forgo the need for a signature on the PFI response, as long as it is delivered from the Freshness Server to the RP over a secure channel, such as an already established SSL session.

12.5.2. THV Data Unit

In response to a request by the signer, the Freshness Server may return a THV to the signer to be placed in his document prior to signing. This THV data unit may contain data pertaining to this particular THV, including:

| | |
|---|---|
| THV serial number | // globally unique (FS_OID, thv_no) |
| Terminal Hash Value | // uchar(20) |
| Periodicity | // frequency of PFI update publication |
| Periodicity Template | // for uneven periodicity, if selected |
| Policy ID | // refers to incorporated terms and conditions |
| Assurance Type | // forgery, E&O, counterparty credit |
| Occurrence Limit | // monetary amount, per claim/occurrence |
| Aggregate Assurance | // max payable for this document |
| Assurance Template | // optional, for time-varying assurance |
| Assurance Expires | // time after which coverage lapses |

The THV serial number help link a particular PFI with the THV that it refreshes. See discussion of assurance templates below.

In general, when an RP receives a document whose digital signature contains such a documentary THV data unit, the RP knows that upon requesting and receiving from the Freshness Server a current PFI data unit, and then relying on the document during the period that PFI remains valid, then the coverages listed in the THV data unit will apply. If the RP is not satisfied the coverages are adequate, it can either reject the transaction or go forward while assuming the risk itself. For the purpose of managing the risks it has elected to retain, if any, the RP can be provided with a self-assurance risk account system similar to the one outlined herein. Or it can outsource the recordkeeping of such retained risks to the Freshness Server, if desired.

If the parties decide to cancel the transaction, the party who originally requested the assurance (with the THV or PFI) can send a signed message to the Freshness Service with a request to de-commit the transaction and release the credit/risk limit associated with the risk commitment previously accepted. Such released limit then becomes immediately available for reuse.

12.5.3. Assurance Templates

An assurance template can be provided, by analogy to the periodicity template disclosed above. Assurance levels can change over time. For example, an Assurance service may wish to accept lower liability during the first 2 hours, in case the signer's private key is reported stolen, followed by standard assurance for some period of days needed to consummate the deal, followed by a declining tail of liability as the transaction becomes more stale, to force parties to clear aging transactions out of the system.

Rather than represent the assurance level curve in the template itself, we could establish some number of “well-known” assurance template patterns that could be represented by codes. For example a policy statement might provide by contract that assurance coverage would be structured as

Assurance Template Code “A” means

{

First 2 hours, 10% of max assurance ;
Next 4 days, 100% of max assurance ;
Next 4 days, assurance declines 20% per day (80, 60, 40, 20, 0) ;

}

The use of assurance templates and associated codes can allow time varying assurance levels to be represented in signatures without needing to be spelled out explicitly.

12.5.4. Agent-Principal Database

The assurance manager of the present invention will also maintain a database of signers and their employers, for purposes of monitoring overall credit risks. Many signers in business environments do not assume primary liability for their signatures, but rather are employees of corporations that often indemnify their officers and directors against all losses other than those due to their own criminal behavior.

Hence while it is desirable to maintain surveillance on the credit and operational risk exposure of a given employee (agent), but from a systemic perspective it is also necessary to maintain surveillance on the overall credit and operational risk exposure of an enterprise (principal) that may have many employees who can sign for it.

There may be an arbitrary number of organizational unit layers between a given signer and a principal that is ultimately liable. (Indeed, in the banking system, one might suggest that the government is the final aggregator of such risks.) The agent-principal database can handle this by being recursive database structure that places agents, units, and principals into a single structure with “agent of” pointers from lower to higher levels.

| | |
|---|---|
| Entity Unique ID | // unique identifier |
| Number of Sub-Entities | // N of children |
| Pointer to Parent | // unique ID of next layer above |
| Name and Title | |
| Location, Jurisdiction, Currency | |
| Authority Specification | |
| Typical or Permitted Doc Types | |
| Delegation Permissions | // can delegate? how far and what? |
| Aggregate Reliance Limit | // max for this entity and all subs |
| Total Reliance Outstanding | // total out now |
| Under 1 Day | // aging buckets (doc counts and $ amts) |
| Days 1-2 | |
| Days 3-5 | |
| Over 5 days | |
| Claims Indicators | // N of claims, size, reason, pattern |

Such a database will allow the assurance service to continually update the total amounts outstanding and assess the credit worthiness of the signers. As more documents are signed, the system will build up risk in the accounts, and as they age out of the system without claims being filed, the risks will pass back out.

12.5.5. Layers of Assurance Coverage

As noted in the table of risks given in Section 5.3 above, the three major risk types are:
1. Negligence or insider fraud by the CA in issuing a digital certificate to an incorrect party resulting in deception and loss to an RP.
2. Negligence or insider fraud by the CA in failing to timely publish a notice of revocation.
3. Risk of loss due to acceptance by an RP of a forged transaction for which neither the CA nor the purported signer can be held liable (see text).
4. Credit risk that the signer will be unable to perform the obligation as agreed in the document.

It is important to note that under US law, a “forged document binds only the forger,” and the purported signer is not liable if he can show that another forged his signature. The RP can sue the forger if desired, but this is generally infeasible since even if they can be found, they may have no assets. Affixing a digital signature using another's private key without their knowledge or consent, especially where the key was stolen, can be defined as an act of forgery.

The practical effect of this is that an RP who has lost money in reliance on a forged document cannot sue either the CA or the purported signer. Hence he requires a special insurance coverage with himself as the beneficiary. However, to facilitate digital commerce, it would not be unreasonable to structure an insurance program under which both CAs and signer/subscribers make contributions to pay for the RPs forgery coverage, since they indirectly benefit from the overall assurance level that allows widespread use of the system.

Therefore one way to construct such an insurance program is to map the risks, insured (liable) parties, assured (claimant) parties, and premium payor/contributors as follows, for example:

| | Insured/ | | | |
|---|---|---|---|---|
| | Liable | Assured/Claimant | Primary | |
| Risk/Peril | Party | Party | Payor | Contributors |
| CA's E&O | CA | Subscriber, RP | CA | Subscriber, RP |
| Forgery | (Forger) | RP | RP | CA, Subscriber |
| Signer E&O | Signer | Signer | Signer | n/a |
| Signer Credit | Signer | RP | Signer | n/a |
| FS's E&O | FS | RP, Subscriber | FS | RP, CA, |
| | | | | Subscriber |

where FS = Freshness Service.

Using a model such as the foregoing, the CA and FS can collect premiums or credit fees from the system participants and allocate those charges to pay the costs of risk capital to post collateral or purchase reinsurance to pay claims arising from the various perils. In a system organized by the CA and/or the FS, the parties will (a) aggregate the risk of loss associated with outstanding client transactions, where the risk commitment has not yet run out or been de-committed, (b) determine and apportion the proportionate risk contributions of the various perils, in view of actual and projected loss experiences, as is customary in insurance and credit risk assessment, (c) determine and apportion the appropriate contributions of each party to the risk premiums or capital charges needed to attract risk capital or a standby letter of credit (LOC) to collateralize the potential losses, taking into account the possible benefits of cross subsidization from parties that benefit greatly from system stability and soundness, (d) set and collect transaction fees in order to pay these premium or capital costs, plus profit, from system participants.

It is anticipated that these risk assurance coverages will be provided primarily on a per-signature basis, because of the unbounded risk associated with a certificate when the associated private key can be used to execute free-form signatures on any data. Also under this invention the signer and relying party can undertake a “risk retention” program, when appropriate. Notably the signer's potential loss from its own E&O perils and any relying party risk that it chooses, can suitably be retained. This system provides that such participants, at the time of communicating with the Freshness Service, can in an authenticated communication forego such coverages (as would benefit them) and retain those risks, and make a corresponding entry in a database on their system, noting each instance and the total outstanding against each counterparty (relying party), signer, and document type. When self-insurance for operational risks is undertaken, it may be appropriate to allocate a portion of the firm's capital against the retained risks, and to internally impose suitable credit or reinsurance fees on the department incurring them.

13. Online Validation Service Models

The problems of digital certificate validation are currently a topic of active research. Various models of certificate revocation, revocation service, and revocation proofs have been proposed. These models are based on a series of fairly complex assumptions about the issuance, use, and processing of certificates used to validate digital signatures. First we will review these assumptions.

13.1. Certificate Usage Phases

As a matter of theory, it appears we can cleanly differentiate between issuance, use, and processing as three separate domains of activity, each having its own goals and concerns.
1. The issuance phase encompasses the gathering and verification of various facts about a user including identity, authority, public key data, and other useful attributes, and culminates in the issuance of a public key certificate that is digitally signed with a private key by a certifying authority, delivered to the user, published in a directory or repository, and placed in an active (unrevoked) status.
2. The use phase includes activities by the user to digitally sign data to provide integrity protection and non-repudiation for storage or transmission, including authentication of messages for legal or security and access control reasons. The use phase begins at issuance and continues through expiration or revocation. When certificates are used to secure the content of ordinary business applications, the developers and users of those applications will mainly be “using” certificates for their desired purpose.
3. The processing phase includes activities undertaken by the recipient or verifier of data or credentials, who has received a digitally signed message, and needs to verify the signature and ascertain the validity (unrevoked) status of the related certificates, in making a determination whether to rely on the digital signature as proof of the facts it purports to assert. If the transaction is later questioned (by any party) the recipient requires a research capability to retrieve the transaction data and re-prove its validity and meaning as of the time it was originally received.

Certificate validation services models must address the needs of this latter processing phase, providing fast and reliable proof of the validity of a digital signature and related assertions contained in a chain of certificates, which can be reliably stored for later research if a transaction or security access event is questioned.

At the same time we would like to achieve this with as little data transmission, processing, and storage as possible, in view of the anticipated high volume of digital commerce, and heavy demands placed on centralized services to meet those needs.

13.2. Data Needed for Processing Phase

The data requirements to process a digital signature may generally include:
1. a copy of the signer's certificate and the certificates of all CAs above the signer,
2. copies of all relevant policies of the CAs that issued the certificates,
3. a recent proof of the non-revoked status of the signer's certificate and the certificates of all CAs above the signer,
4. proof of the time of receipt and processing, to establish that reliance occurred prior to any subsequent revocation,
5. secure, persistent, easily searchable archival storage of the digitally signed transaction, together with the chain of certificates and proofs of non-revocation.

Optionally, the recipient may also desire an identity warranty or assurance that can compensate for losses suffered due to a false certificate or forged signature, in the case of a transaction that involves substantial financial reliance, such as an order to pay money, release valuable goods, or provide access to extremely valuable information, etc. Various proposals have been made to define a validation services processing center that can perform some or all of the above processing for or on behalf of the recipient. This is similar to the functionality already provided by EDI value added networks (VANs).

13.3. Trust Model Assumptions

Certificate validation is made more complex by the assumption of an indeterminate certification path. The current debate assumes that an end user's CA (or any other parent CA in the chain above it) may:
be concurrently certified by a plurality of superior and/or root CAs,
change its root CA during the lifetime of its user certificates,
be cross-certified into a variety of different CA domains,
be issued a new CA certificate by its parent CA, signed with a different key of that parent CA (i.e., parent key transition),
experience a key transition by another CA somewhere in the chain above it, including key transition by the root CA to a new root public key.

Also, due to the computational overhead of digital signing, it is considered infeasible to reissue user certificates en masse whenever there is a CA change or key transition in the chain above.

These conditions can create situations where:
the same user certificate can be validated back upwards to different root CAs, or
there are multiple pathways between two user (sender/recipient) domains, reachable via different cross certification paths.

Such conditions can complicate the certificate processing phase by:
making it more difficult to gather, link together, and verify the necessary certificates,
requiring value judgments as to which certification path or root CA is “better,” or
creating a ranking of the “goodness” of possible certification paths, wherein a less optimal path could be selected if sufficiently timely revocation data is unavailable for a preferred path.

13.4. Current Model Processing Requirements

The indeterminacy of the certification path, and attendant complexities in requesting and processing certificates, can lead to difficult computational and processing problems.

A sender/signer presenting a digitally signed transaction can present any user certificate (without CA certificates), or chain of certificates, that chain back to any root known to the sender, the recipient, or the recipient's validation processing service (VPS).

The recipient or the recipient's VPS accepts the root CA proposed by the sender, or finds another root CA that is acceptable to it (or the recipient), finds and verifies any missing certificates, and then obtains recent proofs of the non-revoked status of all certificates in the chain.

13.5. Simplifying Assumptions

A considerable simplification can be achieved by modifying the assumptions. We can retain the option for indeterminate certificate hierarchies, but require by policy that each individual user certificate will chain back to a specifically identifiable chain of super-CAs and root CA. We call this the designated chain and designated root. This constraint assures us that there is exactly one “correct” certificate chain and root CA for a given end-user certificate.

This can lead to an abbreviated and more efficient proof of validity and non-revocation, using the Micali PFI system discussed herein. Since a given user certificate tells its recipient which chain or root will be used, then a “statement” by an online validation service that the user certificate is valid can be “semantically enhanced” to tell the recipient that the entire chain is also valid and unrevoked. This “statement” is made by the delivery of the proof of freshness to the recipient relying party, either as part of the transmitted message or certificate data unit, or in response to a request by the recipient.

This only works if the online validation service is independent of the user's CA, so that it can be expected to report reliably on the status of all certificates in the chain above. If the user's CA were allowed to make that statement, it would be in the position of confirming that its own certificate was still valid, which is contrary to policy, as we could no longer revoke the user's CA if it were compromised.

13.6. Simplified Validation Processing

13.6.1. Via Independent VPC

To achieve a simplified certificate validation process, we can enhance the THV extension discussed in Section 7.3.1 above to include (a) an identifier of a specific root CA, (b) a policy ID that specifies how validation will occur, and (c) an identifier for a Freshness Server (FS) that is independent of the user's CA.

Starting from the signature on the document received, a recipient can receive or obtain the certificate of the signer that was used to sign the document, containing the THV extension as discussed, and based on the information in that certificate, request a current PFI value from the independent Freshness Server. When received by the recipient, the PFI value will constitute a representation by the Freshness Server that not only is the signer's certificate still valid, but also the certificates in the chain above it to the specified root CA, in accord with the stated policy.

13.6.2. Via Compact Certification (Recertification)

Micali U.S. Pat. No. 5,420,927 relates to a method of public key certification wherein an end user, who has a personal certificate and a chain of certificates above him to some given root CA, can present his chain of certificates to a root CA that creates, signs, and issues to him a single compact certificate. When the user has a certificate signed by his root CA, there is no need for the intervening certificates. This compact certificate embodies all the representations originally made by the intervening CAs, and it will be revoked in the event that any of the intervening certificates is revoked.

Within the scope of the present invention we add to this compact certificate a THV extension as described herein. Now the validity of the entire chain can be conveniently communicated through a PFI against the THV in that single certificate, issued by the root CA or its designated VPC (Freshness Service).

This places an additional burden or risk on the Freshness Service to continually monitor the validity of all the certificates in the user's certificate chain. However, in general the Freshness Service is better positioned to reliably perform and manage this monitoring process than the end users, and the pickup in efficiency gained from a single certificate validated by a single PFI is very considerable.

13.7. Validation of Transactions

Once a recipient (relying party) has received a digitally signed transaction, they have the option of validating it themselves, or sending all or part of the transaction to a third party validation processing service, to validate it for them.

In either case, there is then a requirement to promptly timestamp and archive the transaction, either in whole or in summary. This is especially necessary because certificates that are valid when received may later become invalid. Hence it will be necessary to prove that the recipient relied on the certificate at a time when it was in fact valid. Without such proof parties could claim later that the recipient relied on the certificate after it became invalid. For our purposes, it is enough for the recipient to timestamp its transaction during the validity period of an unexpired PFI.

We will first review the validation process, and then the timestamp and archive process, as they apply to the present invention.

13.7.1. Validator/Requester Process Module

A document recipient, which may be a merchant web server or an e-mail message handler, receives a digitally signed transaction, accompanied by the user's base certificate, or information on where to obtain it.

To validate the transaction, the validator/requester (VR) module of the present invention will first request the user's certificate (if not present) and also the certificates in the chain above the user towards a root CA selected by the recipient (or perhaps the sender), if there is a plurality of root CAs that would be acceptable to the recipient.

The requested certificates may be received accompanied by current PFIs appended by the directory services that furnish them. Upon receiving the certificates, the validator will normally first verify the signatures of each CA in the chain up to the root CA known to the recipient. Then, if the certificates are non-forged, the validator will request current proofs of non-revocation (PNRs) from the sources specified in each certificate. Such PNRs could be current PFIs requested from a Freshness Server (if the certificates contain THVs), or they could be certificate revocation lists (CRLs) or OCSP reponses, etc. Upon receipt of such PNRs, these proofs are also verified for currency, and if all is in order, the original transaction can be accepted and commercially relied upon.

The availability of assurances, if any, may be implied by the THV information or the PNRs, which may contain indications that compensation in stated amounts will be made available if the transaction later causes a loss for specified reasons, as discussed above.

Upon completion of requesting all necessary certificates and PNRs, and verification of that information the validation module will journal the entire transaction, including all the certificates, PNRs, and indications of assurance or risk retention, preferably assigning an internal transaction serial number for future reference. If the transaction is cancelled prior to consummation, that evidence will also be journalled, along with any reduced or rebated fees and credit limits.

13.7.2. Validation Processing Centers

The above described digital signature and certificate validation operations may be considered too complex and risky for many merchants and business organizations to undertake. Hence, it may be desirable to outsource some or all of such operations to a certificate validation processing center (VPC). Such a VPC can greatly reduce the complexity and risk of certificate validation, especially in cases where the recipient's device may be a wireless handheld with limited computational and communication capacities.

Also, in cases involving commercial reliance it will often be desirable to archive the transaction data and accompanying proofs offsite, at a location controlled by a third party, to enhance their value as evidence in potential court proceedings regarding the transaction. Hence, since the recipient would in any case send the transaction data to another party for independent safekeeping, such independent party could also be tasked with verifying the transaction.

It should further be noted that the validation process can be further subdivided into (a) steps performed by the message handler and transaction execution systems (who are the end consumers of the validation process), (b) steps performed by a validation system that may be internal to the recipient's enterprise, but separate from the message handler, and (c) steps performed by an entirely independent party, preferably at a separate geographic location.

From the standpoint of reducing operational risk while retaining as much control as is necessary or desirable, we anticipate that:
1. wireless devices will seek to offload most validation and all archiving, most commonly to an enterprise service for commercial transactions, or to a third party in cases where validation is for authentication only,
2. desktop computers may validate but will also offload all archiving, preferably to an internal service, due to lack of reliability of their long term data storage, and
3. business servers may offload validation to a nearby server, and will prefer to maintain all transaction content internally, for confidentiality reasons, sending out only digests of transactions to a third party.

Furthermore, an internal VPC could at its own option offload certain validation tasks or steps to an external third party VPC service, with or without notice to its internal users, and such offloading could vary. For example, an internal service might offload only at times of peak traffic, or conversely might insource only when its preferred external VPC was swamped and giving poor response time.

The amount of information to be validated that is transmitted to the enterprise or external VPC can vary greatly, and the elements can include, for each signature to be verified:
a. The full text of all original materials used to compute the signature hash value
b. The signature hash value and all associated signature attributes,
c. The certificate of the signer, including certificates of authority if any
d. One or more certificates of CAs in the chain above the signer, as may have been transmitted with the message or been retrieved in a prior step of the process
e. An indication of a certification path, policy, and/or root CA preferred by the recipient
f. Any unexpired proofs of non-revocation, as may have been transmitted with the message or been retrieved in a prior step of the process
g. Any receipts, notices, statements, or status messages regarding any payments made, indebtedness incurred, or liability or risk assumed, transferred, or reserved against.

In performing its assigned steps or tasks, a VPC may:
a. Make directory service requests, for example using the Lightweight Directory Access Protocol (LDAP) to retrieve certificates,
a. Make requests to a Freshness Server for one or more proofs of freshness (PFIs) relating to one or more THVs in the signatures or certificates presented to it,
b. Make requests to other certificate status or digital signature risk assurance services, including ones based on OCSP or Reliance Management.
c. Purchase or incur obligations to pay for guarantees, warranties, costs of capital, or collateral credit risk fees.
d. Receive, transmit, collect, aggregate, summarize or monitor data regarding outstanding risk guarantees, prior operational risk history, outstanding credit risk balances, and prior credit risk history.
e. Provide or transmit detailed or summary statements regarding individual signatures made or verified, current and prior operational and credit risk balances outstanding, current approved customer limits for operational and credit risk, etc. whether to the customer or to any other party in the system, as by prior agreement.
f. Maintain, provide or transmit warnings, bulletins, statements and summaries regarding failed transactions, questioned transactions, reported user errors, lost data messages, or other exceptional events, including analyses of the systemic risk implications of these events, if any.
g. Monitor and report any assumptions or retentions of risk, including active risk balances that are NOT assured or guaranteed by any third party risk capital or credit provider, with representative assessments of the amount and cost of capital that should be internally allocated or charged to cover such risk retentions.
h. Provide or make reference to one or more policy statements or processing practice statements that may govern or interpret the VPC's actions.

13.7.3. Archiving and Recovery

Normally, it will be desirable to journal and archive enough data from a digitally signed transaction to support a robust inquiry and research process, when transactions are questioned or form an element of evidence regarding a legal or business inquiry. When transactions are being investigated, even firms that maintain good records often prefer to submit copies of the same (or related) records obtain from an independent third party source, to avert any suspicion they might have altered their own records. In addition, proofs of freshness or nonrevocation, as well as transaction warranties or risk transfer agreements are all based on relatively short time windows. Hence it is required to establish that reliance occurred when the proofs and coverages were valid.

Hence it will be desirable to provide an archiving service that can receive data in confidence relating to transactions, and provide a confirmation (preferably a digitally signed receipt containing a unique accession number) that can allow the customer to retrieve the data at a later time and verify its authenticity.

13.8. Freshness™ Name Server

Accordingly, under the present invention, in addition to the FS, we provide a Freshness™ Name Server (“FNS”) that can aid the RP in locating and communicating with the FS that issued the THV in question.

We could of course add to the THV data unit address information for the FS responder, such as an Internet domain name, dotted-quad IP address, or a URL/URI. Or we could place such information elsewhere a certificate, such as in the “Authority Information Locator” extension. However, THVs can be placed into many other kinds of data units besides public key digital certificates, so it makes sense to consider providing another means of accessing PFI updates.

We proposed (above) that all THVs and PFIs be uniquely numbered using ASN.1 object identifiers (OIDs), along the following lines:

| | |
|---|---|
| 2.6.6.153 = Valify | // prefix for the system |
| Valify(4) = thvIssuer | // prefix for issuer IDs |
| thvIssuer(1001) = JoesFreshness | // a member of the system |
| thvData(1) = thvSerialNum | // required prefix for THVs |
| thvSerialNum(1234) | // serial number of this THV |
| pfiPeriodNumber(399) | // period number of this PFI |

Thus THV number 1234 issued by “Joe's Freshness Service” might have the globally unique number of 2.6.6.153.4.1001.1.1234, and the unique PFI number for period 399 would become 2.6.6.153.4.1001.1.1234.399.

It is not necessary for all FSs to share an identical system prefix issued by a system manager. Rather, the RP requester and FNS servers can recognize that if any OID is presented as being the OID of a THV, then e.g. the final integer is presumed to be the THV number, which must have a “1” in front of it, and the numbers in front of the “1” are then assumed to represent a specific FS somewhere on the computer network.

Similar to the well known Internet Domain Name System (DNS), each RP requester will have a default local FNS server, to which PFI requests will be directed. The IP address of the local FNS server will be supplied to the RP requester either at the time of installation, or in response to a network broadcast message on the requester's local segment at the time the requester's computer boots up.

13.9. Freshness™ Routers and Firewalls

Normally the FNS will act as a name server, replying with a currently valid IP address in response to an inquiry containing a THV OID. However, it can also act as a router, that receives and forwards the freshness request and relays back the PFI response. This could occur when the FNS handles requests from users and RPs sending freshness requests to several in-house FSs within a semi-closed internal network (intranet) of an enterprise. Most such requests will be satisfied by referring the requester to one of the internal FSs belonging to the enterprise. If however, a requester sends a freshness request to the internal FNS seeking a PFI from an external FS, then the FNS may route the request onto another network segment with external access, and acting as a proxy requester, send the request to the external FS, wait for the reply, and then route the response back onto the internal network segment to the original internal requester.

The router mode may be the preferred one in the enterprise situation, because (a) most large enterprises will wish to operate and control their own FS responders, and (b) the packets of the “freshness protocol” may use unusual port numbers that are blocked by common firewalls. Hence, an FNS with access to two network segments can serve as a “freshness firewall” that is permeable only to freshness requests and responses.

The Freshness Firewall™ (FF) approach can:
1. provide the enterprise with detailed statistics on the degree to which internal users are relying on externally generated THVs, including the identity and location of the FS's in question.
2. allow an enterprise, as a matter of policy, to “block” PFI requests to or responses from certain FS responders, as a matter of policy, that may be deemed unreliable, too expensive, etc., and importantly,
3. allow a requester to anonymize its request.

13.10. Anonymous FNS and FF Services

If Company A obtains a document from Company B, where the freshness service on a given certificate or signature is being provided by an internal enterprise FS of Company B, then for competitive reasons, Company A may not wish to let Company B know that it is checking the freshness of one of its documents. For such situations, entities may provide one or more anonymizing freshness routers on the network, to allow freshness to be checked without revealing who is doing the checking.

To this end we provide under this invention that:
a. a THV may contain an attribute that either allows or bars FNS routers known to be anonymizing from requesting PFIs,
b. an FNS may advertise, via a field in its network messages, that it is available as an anonymizing router,
c. a PFI request that is directed to an FNS router may contain a field that requests the FNS router to either anonymize the request to the FS, or pass through the requester's IP address or other identifying data.

The FNS will communicate periodically with PFI responders and other FNS servers that are visible to it. In the manner of DNS servers, the FNS servers can build and maintain current internal tables of FS names, OIDs, and IP (network) addresses. Using a specific pre-determined broadcast message, an FNS may periodically (such as every half hour) ask all other FSs and FNSs that are locally visible to reply to it, stating (a) their domain names and port numbers, (b) whether they are FSs, FNSs or perhaps both, and (c) if they are FNSs, to reply giving a table or list of all FSs visible to them. This can be important because many FSs may be “invisible” inside of enterprise intranets. Hence the only way that an outsider can know of their existence is if the enterprise FNS, which is visible on the external network, replies back to the broadcast message, giving their names, OIDs, IP addresses, and/or domain names, and listing itself as the freshness firewall™ (FF). Obviously in such cases all requests directed to such internal FSs would have to be sent to the FNS in its capacity as the FF for those internal FSs.

The processes of sending a periodic broadcast message and receiving back replies from content servers, domain name servers, routers, gateways, or firewalls, and using such replies to build an internal table of currently valid IP and network addresses for all FS and FNS servers on a worldwide basis is well known to those skilled in the art of creating and administering Internet domain name servers, routers, gateways, and firewalls.

13.11. System Load Balancing

Such FNS/FS/FF systems can also assist in load balancing and segmentation of THVs across multiple FS responders. For example, certain Freshness™ Servers may receive high volumes of traffic, if their users generate many documents or certificates that are constantly being verified by other users. Hence it may be desirable to segment the THV and PFI databases, e.g., by ranges of THV numbers. For example, given enterprise may have a single “freshness™ service” with a single OID, but wish to segment its expanding database across several different freshness™ servers, say FS1, FS2, and FS3, without getting 2 more OIDs, and possibly needing to reissue prior THVs, etc. Rather, in reply to broadcast messages, the FSs, FNSs and FFs can simply give back not only a list of network addresses of FSs by their base OIDs, but can split an OID across several FSs according to ranges of THV numbers.

If everyone in the entire system identifies themselves using base OIDs assigned by a system operator, then it could be implicit that if a THV ID is included, perhaps followed by another number representing an ending THV, then this states a range for that FS.

Alternatively, if FS operators are allowed to use their own company OIDs, and append codes for PFI server and THV number, then the responses to the FNS broadcast messages will need to include appropriate interpretive or framing information, telling what piece of the OID is the THV number, and giving the range of THV numbers supported by that FS.

When a first FS is queried for a PFI update for a THV that it formerly provided, but has recently been moved to a second FS, the first FS can (a) send back a reply telling the requester to redirect the request to the new IP address, or (b) simply redirect the request to the new IP address. Normally, by the time of the next broadcast message, the network of FNS and FF servers will have removed the old address information and replaced it with the new address information, so such misdirected queries should cease promptly.

Another way to segment a database of THVs to provide a load balanced PFI updating services is to divide the THVs among a plurality of FS responders based on some least significant digits or bits in the THV unique ID or possibly some bits selected from the THV hash value itself. Thus in response to an FNS system broadcast message, an FS might reply that it provides PFI updates on THVs for “Joe's Freshness™ Service” where the OID of the “THV update service” is 2.6.6.153.4.1001.1.______ (THV No), and this particular FS server provides PFI updates on THVs where the last digit of the THV number is “1, 3, or 5”.

This aspect of network traffic management and load balancing on high volume network services is generally known as “content based routing.” It is not necessary to provide content based routing at the FNS level to allow FSs to handle high volumes of traffic, because the FSs themselves can always be designed to provide their own content based routing, at the FS level. However, designing and building a high performance content based routing system remains a relatively difficult and expensive task. By including content based routing into the base design of the FNS, we can reduce the level of effort needed to create and operate FSs, even ones that are intended to handle relatively high volumes, since this is simply provided by the protocol and special content routing servers are not needed at the enterprise FS level.

14. THV Watch List Service

An RP which is processing a digital document, signature, or certificate may need to maintain surveillance over the validity of that digital document, signature, or certificate during a relatively long processing cycle, which may extend over a period of days, as for example in the securities industry, where settlement currently occurs over a 4 day period.

Similarly, a content server (CS) that has received transactions from a client based on the client's digital certificate, may wish to be promptly notified when the client's certificate is suspended or revoked.

Under the present invention, an RP or CS that receives a signature or certificate containing a THV can make a request to the FS that issued the THV and provides PFI updates, asking to be notified (preferably using a push mechanism) when the client's certificate is suspended or revoked. It can do this by placing the THV for the document or certificate on a “watch list” maintained by the FS.

As a further variation, any server (including any FS, FNS, FF, etc.) can offer a watch list service, by receiving the THV to be checked, requesting a PFI from the issuing FS for each successive period, and reporting back to the requester in case it fails to receive a PFI for a given period, or perhaps receives a “negative” PFI (also known as a revocation notification indicator or “RNI”). However, this will often be more inefficient than using the true FS, because of the additional traffic between the watch server and the true FS.

14.1. Watch List Request Message

To request the watch list service, an RP or CS can send the FS a watch list request message (WLRM), which may include one or more of the following:

| | |
|---|---|
| Unique THV ID | // for which watch service is requested |
| Reply via method | // e-mail, http, ftp, socket |
| Reply-to address | // address for method |
| Requester ID | // for requester's use when reply comes back |
| Request Number | // for requester's use when reply comes back |
| Requester name | // optional, not needed |
| Start-End Dates | // when to begin/end watch service |
| Revoke-ACK THV | // THV for requester's ACK |
| Depth of ACK THV | // max N of ACKs requester can send |
| Account Number | // for billing of service fees |
| Service Frequency | // can be less than periodicity |
| Reliance Level/Type | // monetary value or risk class |
| Signature of Requester | // to authorize request and payment |

Prior to sending this WLRM, the requester preferably selects an IRV and uses it to generate a one-time ACK-THV which is placed in the WLRM. This can allow the requester to speedily acknowledge the revocation notification, if sent by the watch service, by merely sending either the IRV, or some prior inverse of the ACK-THV, thereby allowing the watch server to receive positive yet efficient confirmation that the requester received the revocation notification.

In a case where a certificate may be suspended and reinstated, perhaps multiple times, the requester will be required to acknowledge multiple different messages, and hence it is preferable to provide an ACK-THV with a minimum depth of perhaps 12, to allow for future activity on this watch request.

14.2. Watch List Posting Acknowledgement

When the FS receives the WLRM, it can send the RP or CS a watch list posting acknowledgement (WLPA), which may include one or more of the following:

| | |
|---|---|
| Requester ID | // to identify requesting process |
| Request Number | // to link back to specific request |
| Revoke THV | // THV to signify revocation |
| Suspend THV | // THV to signify suspension |
| Resume THV | // THV to signify resumption |
| Service Frequency | // can be less than periodicity |
| Signature of FS | // to confirm receipt of WLRM |

Prior to sending this WLPA, the FS preferably selects a plurality of IRVs and uses them to generate an array of one-time ACK-THVs which are placed in the WLPA. When an event of revocation or suspension occurs, the FS can send a form of RNI derived from one of the IRVs used to generate the THVs. These can provide fast notifications from the watch service, and fast verifications by the requester, without the need for either creation or verification of digital signatures.

The Revoke-THV may have a hashing depth of 1, since it can only be invoked on a single occasion, when a certificate is permanently revoked. However, the system could either (a) omit the Revoke-THV and instead use one that already exists in the certificate, if in fact the certificate contains an N₀ THV, or (b) the Revoke-THV can be encoded to reflect the “revocation reason,” as was explained in detail above. In particular, it may be desirable to encode the Revoke-THV to reflect the revocation reason when there is no N₀ THV in the certificate, since otherwise it may be necessary to incur the overhead of digitally signing a message to convey the reason.

14.3. Suspension and Reinstatement

The use of THVs to Suspend and Resume relates to the concept of certificate suspension found in ANSI X9.5.5 and X9.57, which specify methods for handling digital certificates in the financial services industry. For reasons of liability, it may be desirable to avoid immediately revoking a certificate in case of a report of compromise, because it may be difficult to verify the report of compromise, and if the certificate belongs to a commercial sub-CA, then the superior CA may face large liabilities if it revokes and the report turns out to be a hoax, or if it fails to revoke and the report turns out to be genuine. Hence, the concept of suspension was contributed (by Sudia) to allow a CA to minimize the financial loss caused by a temporary interruption of service to a level low enough to be transferred by contract to the sub-CA.

Under the present invention, when the FS wishes suspend, it sends the first inverse of the suspend THV, and the requester replies by sending the first inverse of its ACK-THV. Then the FS can either send the N₁ inverse for the Revoke-THV, to signal permanent revocation, or else the first inverse of the Resume-THV, to signal resumption, after which the requester replies by sending the second inverse of its ACK-THV.

In a preferred embodiment, the suspend and resume THVs can be combined into a single THV, under which suspend is signified by releasing the first inverse, and resume by releasing the second inverse, etc. Thus an odd inverse means suspend, and an even inverse means resume.

A requester ACK-THV of reasonable depth provides an efficient way for the requester to acknowledge that is has received a watch list service message from the FS. If the requester fails to send the next inverse of its ACK-THV, the FS can resend the message until it receives the ACK. This protocol can offer acceptable service since it is assumed that the FS is reliable, and will keep sending the message until it receives the desired ACK from the requester.

Returning to our original discussions of certificate processing, the method of using alternating odd/even inverses to signify episodes of suspension and reinstatement can be very advantageously used within the certificate, as an enhancement of the revocation reason methodology. We can generate a single THV that can communicate both suspension and revocation information, by first setting a maximum number of suspend episodes, and then segueing into an array of revocation reasons. To accomplish this, we create a THV with a depth of 105, in which the first 100 inverses signify 50 instances of suspension (odd) and resumption (even), and the last 5 indicate revocation reasons.

15. Certification and Freshness™ Services

When issuing certificate to its employees, members, vendors, and/or customers, an enterprise may wish to outsource one or more of the tasks of (a) managing the CA and its private key, (b) identifying the end users, (c) operating the directory service, etc. to a third party service, while at the same time retaining such functionality as it feels may be more appropriate. For example, an enterprise might contract for the issuance of public key certificates to its employees and customers, and yet retain direct control over the ability to revoke those certificates.

It can achieve this by operating its own Freshness Server, wherein the in-house Freshness Server creates and issues the THVs for each such certificate, and securely stores and retains control over the associated IRV and PFIs. When a potential RP seeks to rely on such a certificate it must then query the enterprise Freshness Server for the current PFI (unless it has obtained the PFI from another source).

In this manner, the enterprise can (a) rid itself of the task of issuing certificates and operating the public directory or repository, yet (b) retain internal control over the critical process of activating, deactivating, suspending, and revoking the certificates of its employees, etc., and (c) as a side benefit, maintain real-time surveillance over reliance activity, to learn about usage patterns and watch for anomalies.

In addition, when operated by an enterprise or other organization, the Freshness Server can be equipped to receive information from other authentication or network security systems already existing in the enterprise. Such information might take the form of real time messages or batch (multi-transaction) files (a) transmitted to the FS telling it to revoke individual's certificates, or to initiate the process of issuing new ones, or (b) transmitted by the FS to other systems informing them of new certificates received and activated, as acknowledgements of receipt of revocation requests, or of notifications of the time at which the last PFI for a revoked certificate will expire, and the like.

16. Testing for Weak Hash Chains

There is a remote possibility that when selecting an IRV, generating a hash chain, and issuing a THV for use in a certificate (or signature, etc.) there could be a “bad” choice of the IRV which could lead to a degenerate hash chain. For example, if the IRV were 100, there might be a recurrence of that or other values in the subsequent chain.

As with any system that uses random numbers from a random number generator (RNG), there is always the possibility that the RNG or its associated circuitry might fail in some way, and output ‘0’ or some other improper value. When generating hash chains, it is therefore desirable to test¹ them prior to releasing them for use in an actual financial security system. Such tests may be of several kinds.
The US National Institute of Standards and Technology (NIST) is currently devising a suite set of tests to to monitor the quality of RNG output, in some cases continually on an accumulated basis. It is expected that this will be released as a Federal Information Processing Standard (FIPS).

A RNG analyzer process may be provided that collects and accumulates the entire series of random numbers generated, analyzes them for the degree of randomness according to numerous possible mathematical tests, and reports the results to the system users. If they see that the test results show any lowered degree of randomness, they can take corrective action, including replacing or re-initializing the RNG.

A simple IRV test may be provided to counter the possibility of degenerate IRVs, such as by requiring a certain percentage of 1s and 0s, and rejects proposed IRVs that contain almost entirely one or the other.

A series test may be provided to analyze the entire hash-chain after it has been generated. Such a test could begin by sorting all the hash values and checking for any values that happened to be identical or to contain any high percentage of overlap in bit sequences. We can also use one or more tests to compute a randomness metric for the entire series. Series that displayed a level of randomness below a certain pre-determined level would be rejected, and their THVs would not be released or used for any purpose.

Also, the system could substantially over-run the required length, and generate (e.g.) several hundred or thousand more values than needed, and perform the series test on the elongated series, to assure that degenerate results do not occur later, which could lead to weakness or an ability to guess values earlier in the sequence.

As noted in the Micali patent, the hash chain process can also be strengthened by adding some additional data, such as the period number, into the computation of the next value. It could also be strengthened by alternating the choice of hash function (e.g., SHA-1 or MD5) from one period to the next. The choice could be based on (a) one for even periods, the other for odd, or (b) whether some given bit in the hash value for previous period was even or odd, etc.

17. Optimized Storage of Hash Values

In a Freshness Server, under a default implementation, we can generate the current periodic freshness indicator (PFI) value by either:
a. starting from the initial random value and hashing forward all the way down to the current period, each time we wish to publish a value, or
b. pre-computing and storing the entire hash chain and merely outputting the value for the current period, when requested.

The former method consumes little disk storage space, but has the drawback of requiring excessive computation relative to each period. The latter requires very little computation per period, but requires excessive disk storage space.

For a certificate with a lifetime of 2 years and a freshness revocation periodicity of 2 hours, 8,760 PFI values are required. Estimating conservatively 30 bytes of disk storage per PFI, then 263,000 bytes of storage are required for each certificate issued. In turn if 1 million certificates are issued, this requires 263 GB (billion bytes) of storage, which is excessive and unnecessary. Conversely, however, we do not wish to be required to hash forward ˜8,000 values each time we need to publish a new PFI value.

In an improved system, under the present invention, we disclose a method for pre-computing and storing PFI values requires uses both less space and less computation.

To generate a THV, we start with an IRV and hash all the way to the end of the projected series. We perform appropriate tests of randomness, to assure that the series is secure, and has no apparent weaknesses. If accepted, the THV is embedded into the certificate, and after it is issued, the PFI value for the first period is released.

We do not wish to store all 8,760 values, as in the preceding example, so instead we save only (in this example) 147 of them. First we retain every 100^{th} value (87 values), and second we retain the last 60 values. Under our estimate of 30 bytes per value, this takes up 4,400 bytes of storage space per cert, and for 1 million certs, about 4.4 GB, which is more manageable.

We publish the last 60 values at 2 hour intervals (back to position 8,700) and then take the 86^{th} value (for position 8,600) and hash forward to generate (in this example) the PFIs for the next 100 periods (i.e., periods 8,600 to 8,699), which now require 186 values×30 bytes=5,580 bytes of storage.

We thus keep total storage requirements relatively modest, while at the same time, we are not required to hash forward more than 100 periods at a time, and this only upon the 100^{th} period, when we have run out of pre-computed values to dispense.

It will also be advantageous to “stagger” the intermediate PFI retention positions so that the requirement of hashing forward the next 100 values only arises for 1/100 of the certs at any given time. That is, for each hash chain, we select a retention period offset value, which in the present example would be a number for 0 to 99. This retention period offset value could be assigned deterministically, such as from the last 2 digits of the certificate (or THV) serial number, or randomly based on the output of a random function at the time the series was generated (e.g., the 2 least significant decimal digits of the THV). The purpose of the staggered offsets is to distribute the computation burden, and keep it from bunching up at certain time periods.

Another way to minimize processing or computational bottlenecks is to perform the hash-forward calculations during the 2-hour interval of time afforded by the periodicity. Once the values for the current period have been published, and copied to a first database server that is visible to the Internet, the system can begin generating the values for the next period, and using them to populate a second database server, generally one that is not currently connected to the Internet. Then, upon the start of the next period, we connect the newly populated second database server to the Internet, disconnect the first database server, and begin populating it with the PFI values for the next period.

It will be clear to those skilled in the art that the selection of PFI retention positions can occur at greater or lesser intervals, with a corresponding tradeoff of required storage space versus run time computation. Storage space and computation both involve cash costs to provide the necessary resources. For any given choice of hardware performance, equipment cost (CPU and disk), database size, and periodicity, one can state and solve a simultaneous equation that yields the optimal (cheapest) space tradeoff, depending on the speed of disk access versus the cost of disk storage, without falling below the desired performance threshold.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

18. Freshness™ Network Services

When a relying party (RP) receives or examines a certificate, message, access control ticket, or any other data unit that contains a THV unit, and wishes to discover whether the party (usually a PFI responder) that issued the THV still stands by the assertion that is linked with the THV, the RP will need to locate the FS or other THV issuer, and request a current PFI that will verify against that THV.

1. (canceled)

2. A method of managing revocation status for public key certificates, comprising:
determining an initial random value;
applying a one-way hash function N times to the initial random value to obtain a final hashed value;
a certificate authority issuing a public key certificate that includes the final hashed value digitally signed by the certificate authority;
a third party receiving the digital certificate and a first periodic freshness indicator at a first time T1;
the third party applying the one-way hash function to the first periodic freshness indicator M times to obtain a first final value and caching intermediate results thereof, where M is a number of refresh intervals from the date of issuance of the digital certificate to T1;
the third party confirming that the digital certificate has not been revoked prior to T1 by confirming that the first final value equals the final hashed value of the digital certificate; and
in response to receiving a second periodic freshness indicator at a time T2 that is after T1, the third party using one of the cached intermediate values corresponding to T2 to confirm that the certificate has not been revoked prior to T2.
